(19) United States
(12) Patent Application Publication
(10) Pub. No.: US 2007/0127056 A1
(43) Pub. Date: Jun. 7, 2007

(54) IMAGE PROCESSING APPARATUS, IMAGE PROCESSING METHOD AND PROGRAM, AND STORAGE MEDIUM THEREFOR

(75) Inventors: Yasuhiko HIRANO, Yokohama-shi (JP); Yasuyuki Nakamura, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/566,431

(22) Filed: Dec. 4, 2006

(30) Foreign Application Priority Data
Dec. 6, 2005 (JP) 2005-352207
Feb. 20, 2006 (JP) 2006-043157

(51) Int. Cl. G06K 15/00

(52) U.S. Cl. 358/1.14; 358/3.28

(57) ABSTRACT

Conventionally, the same synthesis method is applied uniformly for an area (such as a photographic/graphics area), wherein a document image is placed on top for combination and an area (such as a character area or an area having no attribute), wherein a predetermined image is placed on top for combination. In contrast, a method appropriate for the characteristic of each area in a document image is employed, and a predetermined image is combined with the individual areas of the document image.

### BACKGROUND OF THE INVENTION

1. Field of the Invention

The present invention relates to an image processing apparatus for combining an original image and a predetermined image to obtain a combined image, a method and a program for controlling the image processing apparatus, and a storage medium therefor.

2. Description of the Related Art

Conventionally, for the related art, a special sheet, called a forgery prevention sheet, is employed in which a character string such as “COPY” has been embedded, so that for an original, this character string can not easily be discerned by a casual human observer. However, on duplicate matter, prepared by copying a forgery prevention sheet, these embedded characters come up to be displayed. As a result, documents prepared using these forgery prevention sheets can easily be distinguished from duplicates thereof, and this tends to give a third party a pause in even using a duplicates of original documents.

Because of the effects available with forgery prevention sheets, they have been employed for the preparation of certificates of residence or application forms. However, compared with plain paper, the forgery prevention sheets are expensive and further, only a character string embedded in a sheet manufacturing process, can appear on a duplicate.

Under these circumstances, attention has been drawn to a new technique that provides much the same effects as those available with forgery prevention sheets (see Japanese Patent Application Laid-Open No. 2005-136953). According to this technique, original document data, prepared using a computer, and copy-forgery-inhibited pattern image data (also called a copy braking pattern) are combined in a printer, and copy-forgery-inhibited pattern-combined image data obtained through this combination is output on a plain paper. For example, a character string is embedded in the copy-forgery-inhibited pattern image data, and that therefore, when a duplicate is obtained by copying a copy-forgery-inhibited pattern-combined image, the combined character string appears, as it does when a forgery prevention sheet is employed. Since this technique permits the use of plain paper, an original document can be prepared at a low cost, compared with when a forgery prevention sheet is employed. Further, by using this technique, new copy-forgery-inhibited pattern image data can be generated each time an original document is prepared, and thus, an advantage of this technique is that the color of a copy-forgery-inhibited pattern image and the contents of a character string that is to be combined can be freely determined.

This copy-forgery-inhibited pattern image is formed while using a “remain” area and a “disappear” (or “a density reduced, compared with the ‘remain’ area”,) area on a duplicate. Since for an original document the reflection densities of these two areas are substantially equal, a casual human observer will be unable to visibly identify an embedded character string, such as “COPY”. Note that in this instance, “remain” is used to define a portion of the image on an original document that is reproduced on a duplicate, and “disappear” is used to define a portion of the image on the original document that is not reproduced on a duplicate, and that the reflection density can be measured using a reflection densitometer.

Hereinafter, the “remain” area on a duplicate is called a “latent-mark portion”, and the “disappear” (or “fading, compared with the ‘remain’ area”,) area on the duplicate is called a “background portion”.

FIG. 24 is a diagram showing the state of dots in a copy-forgery-inhibited pattern image. An area wherein dots are concentrated is a latent-mark portion, and an area wherein dots are more widely spread is a background portion. Dots in the two areas are generated by different half tone dot processes or different dithering processes. For example, dots in the latent-mark portion are generated through the half tone dot process for a small number of lines, and dots in the background portion are generated through the half tone dot process for a large number of lines. Or, dots in the latent-mark portion are generated by using a dot concentration type dither matrix, and dots in the background portion are generated by using a dot dispersion type dither matrix.

The reproduction capability of a copying machine depends on the input resolution and the output resolution of the copying machine, and thus, the reproduction capability of a copying machine is limited. Therefore, in a case where dots to be formed in the latent-mark portion of a copy-forgery-inhibited pattern image are larger than those reproducible by the copying machine, and where dots to be formed in the background portion are smaller than those reproducible by the copying machine, generally the dots in a latent-mark portion on a duplicate can be reproduced and the dots in the background portion is hard to be reproduced. As a result, the latent-mark portion on a duplicate appears darker than the background portion. Hereinafter, a phenomenon in which a latent-mark portion on a duplicate is darker than a background portion, and thereby an embedded character string or the like comes up to be visible is called image appearing.

FIGS. 25A and 25B are diagrams illustrating this image appearing process. Referring to these drawings, it is conceptually indicated that concentrated dots (large dots) are reproduced on a duplicate, and dispersed dots (small dots) are not exactly reproduced.

The design of a copy-forgery-inhibited pattern image is not limited to the one described above, and any design is appropriate so long the design incorporates a character string such as “COPY”, a symbol or a figure, for example, that appears on a duplicate and that a person can visually identify. Further, in order to achieve the purpose of the copy-forgery-inhibited pattern image, a character string, such as “COPY”, may be printed in white on a duplicate. In this case, naturally, the area in which “COPY” is printed is called a background portion.

A technique for determining a combination method for a document image and a copy-forgery-inhibited pattern image is disclosed in Japanese Patent Application Laid-Open No. 2005-136953. According to this document, for combination when a filled area is not present in a document image, the document image is overwritten over a copy-forgery-inhibited pattern image, and therefore, deterioration of the image quality of the document image by the copy-forgery-inhibited pattern image does not occur. On the other hand, for combination when the filled area is present in the document image, the copy-forgery-inhibited pattern image is overwritten over the document image, and therefore, the disappearance of the copy-forgery-inhibited pattern image corresponding to the filled area of the document image is avoided.

Furthermore, in Japanese Patent Application Laid-Open No. 2005-136953, not only is a technique disclosed for determining whether the filled area is present in a document image, but also a technique for employing the ratio of the filled area present in the document image to determine which image should be overwritten.

However, when the technique disclosed in Japanese Patent Application Laid-Open No. 2005-136953 is employed, the same synthesis method is applied for the entire face of a document image. And as a result, the same synthesis method would be uniformly performed for an area (e.g., a photograph/graphics area) for which the original image should be placed on top for combination and for an area (e.g., a character area or an area having no attributes) for which the copy-forgery-inhibited pattern image should be placed on top.

### SUMMARY OF THE INVENTION

An object of the present invention is to combine a predetermined image and individual areas of a document image while using methods appropriate for the characteristics of the individual areas in the document image. It should be noted that the predetermined image will include a copy-forgery-inhibited pattern image.

In a first aspect of the present invention, there is provided an image processing apparatus generating a combined image by combining a copy-forgery-inhibited pattern image and an original image, said apparatus comprising:
an attribute determining unit which determines a type of attribute information of each of pixels in the original image based on a pixel value of the pixel in the original image; and
a generating unit which generates the combined image by determining a pixel value of the pixel in the combined image, based on the type of the determined attribute information of a pixel in the original image which is corresponding to the pixel in the combined image.

In a second aspect of the present invention, there is provided an image processing apparatus generating a combined image by combining a copy-forgery-inhibited pattern image and an original image, said apparatus comprising:
an attribute determining unit which determines a type of attribute information of each of pixels in the original image based on a type of an object including the pixels; and
a generating unit which generates the combined image by determining a pixel value of the pixel in the combined image, said pixel corresponding to the pixel in the original image, based on the type of the attribute information determined by said attribute determining unit.

In a third aspect of the present invention, there is provided an image processing apparatus as claimed in claim 5, wherein the first type of the attribute information includes picture attribute information and graphic attribute information,
the second type of the attribute information includes character attribute information and line attribute information.

In a fourth aspect of the present invention, there is provided an image processing apparatus generating a combined image by combining an original image and a first image, said apparatus comprising:
an attribute determining unit which determines which type of attribute information does the type of the attribute information of each of pixels in the original image correspond to, among predetermined plurality of types of attribute information;
a selecting unit which selects at least one type of attribute information from the predetermined plurality of types of attribute information, on the basis of an instruction by a user; and
a generating unit which generates the combined image by determining a pixel value of the pixel in the combined image, said pixel corresponding to the pixel in the original image, based on the type of the attribute information determined by said attribute determining unit and the type of the attribute information selected by said selecting unit.

In a fifth aspect of the present invention, there is provided A control method of an image processing apparatus generating a combined image by combining a copy-forgery-inhibited pattern image and an original image, said method comprising:
an attribute determining step for determining a type of attribute information of each of pixels in the original image based on a pixel value of the pixel in the original image; and
a generating step for generating the combined image by determining a pixel value of the pixel in the combined image, based on the type of the determined attribute information of a pixel in the original image which is corresponding to the combined image.

In a sixth aspect of the present invention, there is provided a control method of an image processing apparatus generating a combined image by combining a copy-forgery-inhibited pattern image and an original image, said method comprising:
an attribute determining step for determining a type of attribute information of each of pixels in the original image based on a type of an object including the pixels; and
a generating step for generating the combined image by determining a pixel value of the pixel in the combined image, said pixel corresponding to the pixel in the original image, based on the type of the attribute information determined by said attribute determining step.

In a seventh aspect of the present invention, there is provided a control method of an image processing apparatus generating a combined image by combining an original image and a first image, said method comprising:
attribute determining step for determining which type of attribute information does the type of the attribute information of each of pixels in the original image correspond to, among predetermined plurality of types of attribute information;
selecting step for selecting at least one type of attribute information from the predetermined plurality of types of attribute information, on the basis of an instruction by a user; and
generating step for generating the combined image by determining a pixel value of the pixel in the combined image, said pixel corresponding to the pixel in the original image, based on the type of the attribute information determined by said attribute determining step and the type of the attribute information selected by said selecting step.

According to the combination method of the present invention, a predetermined image can be combined with individual areas of a document image by using methods appropriate for the characteristics of the individual areas of the document image.

Further features of the present invention will become apparent from the following description of exemplary embodiments (with reference to the attached drawings).

### BRIEF DESCRIPTION OF THE DRAWINGS

FIG. 1 is a diagram showing the general configuration of an image forming system;

FIG. 2 is a diagram showing the external appearance of the input/output device of an image forming apparatus;

FIG. 3 is a diagram showing the general configuration of the image forming apparatus;

FIG. 4 is a conceptual diagram showing tile data;

FIG. 5 is a block diagram showing a scanner image processing section;

FIG. 6 is a block diagram showing a printer image processing section;

FIG. 7 is an explanatory diagram showing the copy screen of an operating portion;

FIG. 8 is an explanatory diagram (1) showing the copy-forgery-inhibited pattern setup screen in the operating portion;

FIG. 9 is an explanatory diagram (2) showing the copy-forgery-inhibited pattern setup screen in the operating portion;

FIG. 10 is an explanatory diagram (3) showing the copy-forgery-inhibited pattern setup screen in the operating portion;

FIG. 11 is a diagram showing a method for generating copy-forgery-inhibited pattern image data;

FIG. 12 is a diagram showing a dot concentration type dither matrix;

FIG. 13 is a diagram showing a dot dispersion type dither matrix;

FIG. 14 is a diagram showing a concentration type dither pattern;

FIG. 15 is a diagram showing a dispersion type dither pattern;

FIG. 16 is a flowchart showing the processing for combining, with copy-forgery-inhibited pattern image data, document image data obtained by reading a document, and for generating a combined image and outputting the combined image on a sheet;

FIG. 17 is a flowchart 1 for explaining the process at S1610;

FIG. 18 is a flowchart 2 for explaining the process at S1610;

FIG. 19 is an explanatory diagram 1 showing the setup screen of the operating portion;

FIG. 20 is an explanatory diagram 2 showing the setup screen of the operating portion;

FIG. 21 is a diagram showing an example document image;

FIG. 22 is a diagram showing an example combined image obtained by combining a copy-forgery-inhibited pattern image with the entire area of a document image;

FIG. 23 is a diagram showing an example combined image obtained by combining a copy-forgery-inhibited pattern image with one part of the area of a document image;

FIG. 24 is a diagram showing an example copy-forgery-inhibited pattern image;

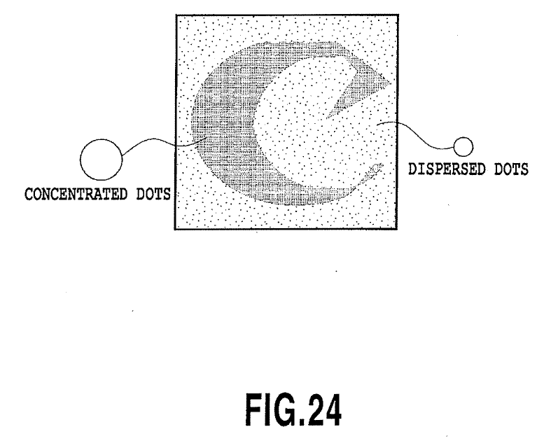

FIGS. 25A and 25B are diagrams showing example copy-forgery-inhibited pattern images respectively before and after the image appearing process is performed;

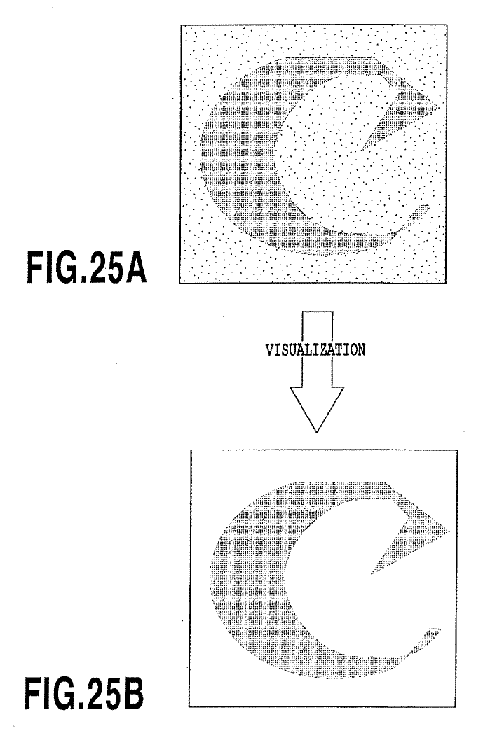

FIG. 26 is a flowchart 3 for explaining the process at S1610;

FIG. 27 is a block diagram showing an example configuration of a printer control system according to one embodiment of the present invention;

FIG. 28 is a block diagram showing an example configuration for the printing operation of a host computer shown in FIG. 27;

FIG. 29 is a flowchart showing the copy-forgery-inhibited pattern printing processing for the embodiment of the invention;

FIGS. 30A to 30C are diagrams for explaining the concept for changing objects to blocks;

FIG. 31 is a diagram for explaining the structure of an object block;

FIG. 32 is an enlarged diagram showing an example copy-forgery-inhibited pattern image, i.e., one part of a latent-mark;

FIGS. 33A and 33B are diagrams for explaining a reduction in size for of copy-forgery-inhibited pattern blocks;

FIG. 34 is a diagram for explaining an offset position adjustment between object blocks and a copy-forgery-inhibited pattern image;

FIG. 35 is an enlarged diagram showing the positional relationship of an object block and surrounding copy-forgery-inhibited pattern blocks;

FIG. 36 is a diagram for explaining that a copy-forgery-inhibited pattern block read start address is to be shifted a distance equivalent to an offset in order to adjust an offset position;

FIG. 37 is a diagram showing an arrangement when a copy-forgery-inhibited pattern image is inclined; and

FIG. 38 is a diagram showing an example for calculating inclinations for two object blocks when inclined copy-forgery-inhibited pattern blocks are set.

### DESCRIPTION OF THE EMBODIMENTS

The best modes for carrying out the present invention will now be described while referring to the accompanying drawings.

In the explanation for the embodiments of this invention, assume that a character string or a symbol is designated as the latent-mark portion of a copy-forgery-inhibited pattern image, and is to be combined with an arbitrary content image to output the original document (original printed matter). Furthermore, assume that on a duplicate the background portion is printed lighter than the latent-mark portion, so that a latent character string or a latent symbol becomes visible.

However, the copy-forgery-inhibited pattern image used for this invention is not thereby limited. For example, as is described above, a latent character string or a latent symbol maybe set up as a background portion, and the surrounding area of the background portion may be set up as a latent-mark portion, so that either the latent character string or the latent symbol can be represented in outline character or the like on a duplicate.

The present invention is not defined in accordance with the type of copy-forgery-inhibited pattern image, the copy-forgery-inhibited pattern image generation process, the color, the shape and the size of the copy-forgery-inhibited pattern image.

Different dot patterns may be respectively arranged in the latent-mark portion and the background portion of an original document, so that different moires may be generated in the latent-mark portion and the background portion of a duplicate to cause a reflection density difference.

Further, various available methods, such as a method of employing lines, instead of dots, for forming a copy-forgery-inhibited pattern image, can be employed.

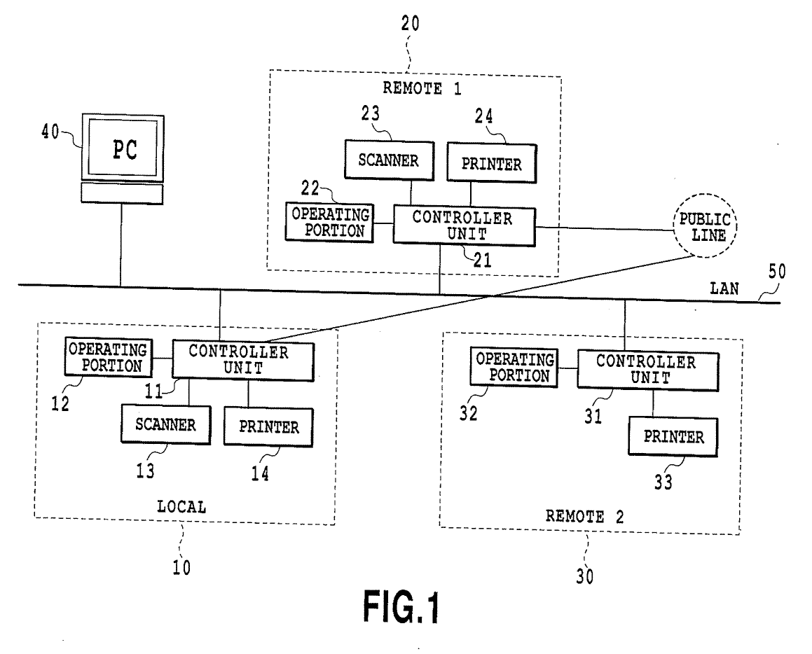

### FIRST EMBODIMENT

<Printing System (FIG. 1)>

A first embodiment of the present invention will now be described in detail while referring to the drawings. FIG. 1 is a block diagram showing the configuration of a printing system according to this embodiment. In the printing system, a host computer 40 and three image forming apparatuses 10, 20 and 30 are connected to a LAN 50; however, the number of units connected to the printing system of this invention is not limited to three. Further, although a LAN is employed in this embodiment, no limitation is placed on the connection methods used. For example, an arbitrary network, such as a WAN (a public line), a serial transmission method, such as USB, or a parallel transmission method, such as centronics or SCSI, may also be employed.

The host computer (hereinafter referred to as a PC) 40 has the functions of a personal computer. The PC 40 can exchange a file or an email via the LAN 50 or a WAN by using FTP or SMP protocol. Also, the PC 4 can transmit printing instructions, through a printer driver, to the image forming apparatuses 10, 20 and 30.

The image forming apparatuses 10 and 20 have the same configuration. The image forming apparatus 30 includes only a printing function, and does not include a scanner unit with which the image forming apparatuses 10 and 20 are equipped. Hereinafter, to simplify the explanation, the image forming apparatus 10 is employed, and the configuration thereof will be described in detail.

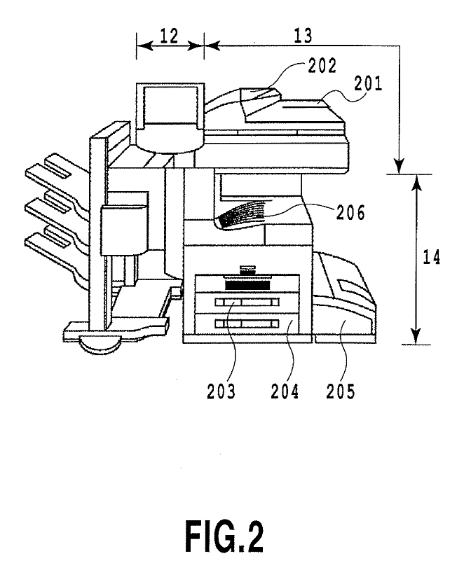

The image forming apparatus 10 includes: a scanner unit 13, which is an image input device; a printer unit 14, which is an image output device, a controller unit 11, which controls the entire image forming apparatus 10; and an operating portion 12, which serves as a user interface (UI).

<Image Forming Apparatus 10 (FIG. 2)>

The external appearance of the image forming apparatus 10 is shown in FIG. 2. The scanner unit 13 exposes and scans the image on a document and transmits thus obtained reflected light to a CCD, and converts image information into an electric signal. The scanner unit 13 further converts the electric signal into a luminance signal for R, G and B colors, and outputs this luminance signal as image data to the controller unit 11.

A document is placed on a tray 202 of a document feeder 201. Then, when a user enters a reading start instruction through the operating portion 12, the controller unit 11 gives the document reading instruction to the scanner unit 13. Upon receiving this instruction, the scanner unit 13 separately feeds the sheets of the document on the tray 202 of the document feeder 201, and performs the reading of the document. To read a document, instead of using the automatic feeding performed by the document feeder 201, individual pages of the document may be positioned on a glass panel (not shown) and scanned by moving an exposure unit.

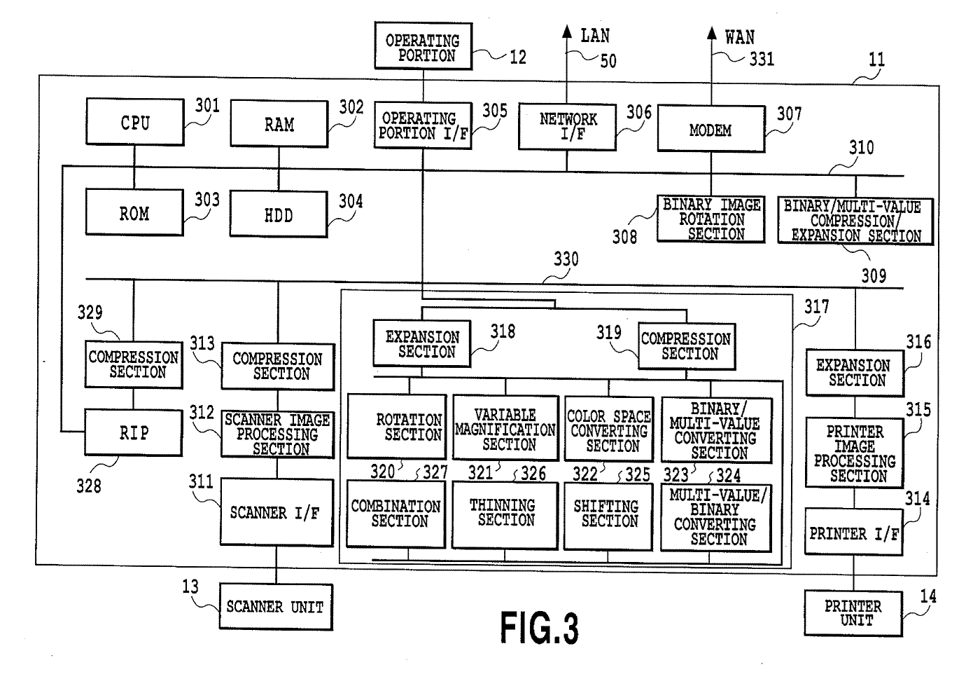

The printer unit 14 is an image forming device that forms, on a sheet, image data received from the controller unit 11. In this embodiment, the image forming system is an electrophotographic system that uses a photosensitive drum or a photosensitive belt. However, the present invention is not limited to this system, and can also be applied for an inkjet system that ejects ink through fine nozzle arrays to print an image on a sheet. A plurality of sheet cassettes 203, 204 and 205 are provided for the printer unit 14 that permit a user to select different sheet sizes or different sheet feed directions. A delivery tray 206 is provided to which printed sheets are discharged.

<Detailed Explanation of the Controller Unit 11 (FIG. 3)>

FIG. 3 is a block diagram for explaining in more detail the configuration of the controller unit 11 of the image forming apparatus 10.

The controller unit 11 is electrically connected to the scanner unit 13 and the printer unit 14, and is also connected to the PC 40 and an external apparatus via the LAN 50 and a WAN 331. With this arrangement, image data and device information can be input and output.

A CPU 301 employs, for example, a control program stored in a ROM 303 to collectively control the access of the various devices that are currently connected, and also to collectively control the various processes that are performed by the controller unit 11. A RAM 302 is a system work memory used by the CPU 301 and also as a memory for temporarily storing image data. The RAM 302 is constituted by a SRAM, the contents of which are retained after the power is switched off, and a DRAM, the contents of which are erased after the power is switched off. In the ROM 303, a boot program for the apparatus is stored. An HDD 304, i.e., a hard disk drive, is used to store system software and image data.

An operating portion I/F 305 is an interface unit for connecting a system bus 310 and the operating portion 12. The operating portion I/F 305 receives, via the system bus 3310, image data to be displayed on the operating portion 12 and outputs the image data to the operating portion 12, and also transmits to the system bus 310 information received from the operating portion 12.

A network I/F 306 is connected to the LAN 50 and the system bus 310 for the input and output of information. A modem 307 is connected to the WAN 331 and the system bus 310 for the input and output of information. A binary image rotation section 308 converts the direction in which image data is to be transmitted. A binary image compression/expansion section 309 converts the resolution of image data to be transmitted into a predetermined resolution or a resolution that is consonant with the capability of a destination apparatus. For data compression or expansion, a JBIG, MMR, MR or MH system is employed. And an image bus 330, which is used as a transfer path for the exchange of image data, is either a PCI bus or is formed in accordance with IEEE 1394 provisions.

A scanner image processing section 312 performs corrections, or works with or edits image data that are received from the scanner unit 13 via a scanner I/F 311. The scanner image processing section 312 determines whether received image data is for a color document or for a black and white document, or for a character document or a photograph, and attaches the determination results to the image data. This associated information is called attribute data. The process performed here by the scanner image processing section 312 will be described later in detail.

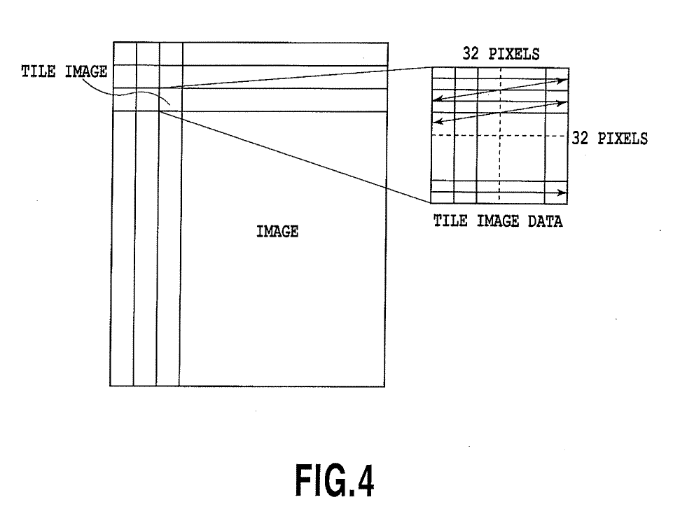

A compression section 313 receives the image data, and divides the data into blocks of 32 pixels×32 pixels each. The 32×32 pixel image data is called tile data, and FIG. 4 is a conceptual diagram showing this tile data. In a document (a sheet medium before scanning), an area corresponding to tile data is called a tile image. For tile data, average luminance information for a block of 32×32 pixels and the coordinate position of a tile image on a document are additionally provided as header information. The compression section 313 further compresses the image data consisting of multiple sets of tile data. An expansion unit 316 expands image data consisting of multiple sets of tile data, performs raster development for the data, and then transmits the resultant data to a printer image processing section 315.

The printer image processing section 315 receives the image data from the expansion section 316, and performs image processing for the image data while referring to attribute data that are added to the image data. The image data obtained through the image processing are then output to the printer unit 14 via a printer I/F 314. The processing performed by the printer image processing section 315 will be described in detail later.

An image converting section 317, which performs a predetermined conversion for the image data, includes the following processors.

An expansion section 318 expands received image data, and a compression section 319 compresses received image data. A rotation section 320 rotates received image data, and a variable magnification section 321 performs a resolution conversion process (e.g., from 600 dpi to 200 dpi) for received image data. A color space converting section 322 changes the color space for received image data. The color space converting section 322 employs a matrix or a table to perform a well known under color removal process, a well known LOG conversion process (RGB→CMY), and a well known output color correction process (CMY→CMYK). A binary/multi-value converting section 323 converts binary tone image data into 256 tone image data, while a multi-value/binary converting section 324 employs a method, such as an error diffusion process, to convert received 256 tone image data into binary tone image data.

A combination unit 327 combines two sets of received image data and generates one set of image data. For the combination of two sets of image data, there is a method whereby the average value for the luminance levels of pixels to be combined is regarded as a synthesis luminance value, or a method whereby a greater luminance value of a pixel to be combined is regarded as the luminance level of the resultant pixel after synthesis. Further, there is also a method whereby a smaller luminance level of a pixel to be combined is regarded as the luminance level after synthesis, or a method whereby the luminance level employed after synthesis is determined through the logical sum calculation, the logical product calculation or the exclusive OR calculation of pixels to be combined. These synthesis methods are all well known. A thinning section 326 then performs a resolution conversion by thinning out the pixels of received image data, and generates image data for which the count is ½, ¼ or ⅛ that which is received. Thereafter, a shifting section 325 adds a margin portion to, or deletes a margin portion from, the received image data.

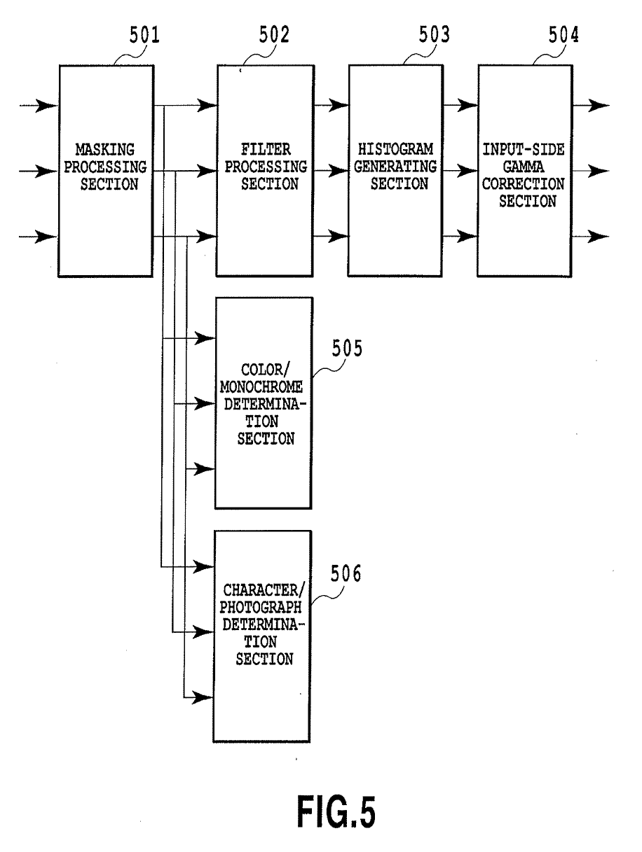

An RIP 328 receives intermediate data that are generated based on PDL code data transmitted by the PD 40, and generates (multi-valued) bitmap data.

<Detailed Explanation of the Scanner Image Processing Section 312 (FIG. 5)>

FIG. 5 is a diagram showing the internal arrangement of the scanner image processing section 312.

The scanner image processing section 312 receives image data composed of RGB luminance signals of 8 bits each. A masking processing section 501 converts these luminance signals into standard luminance signals that do not depend on the filter color of the CCD.

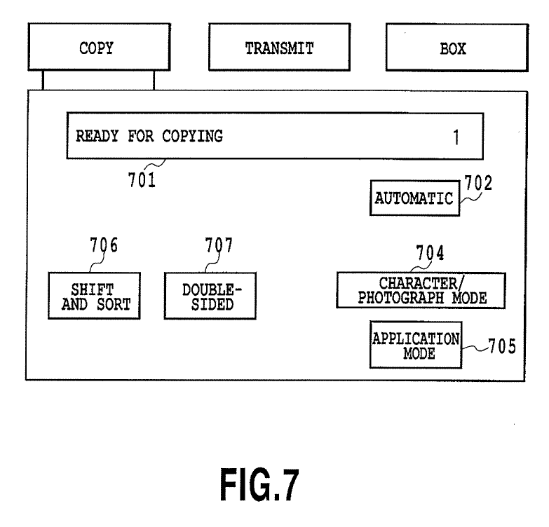

A filter processing section 502 arbitrarily corrects the spatial frequency of the received image data, and the filter processing section 502 employs, for example, a 7×7 matrix to perform a computation for the received image data. For a copying machine or a multifunctional apparatus, a user can select a character mode, a photograph mode or a character/photograph mode as a copy mode by manipulating a tab 704 in FIG. 7. When the character mode is selected by the user, the filter processing section 502 passes the entire image data through a character filter, and when the photograph mode is selected, the filter processing section 502 passes the entire image data through a photograph filter. Then, when the character/photograph mode is selected, the filter processing section 502 selectively changes a filter for each pixel in accordance with a character/photograph determination signal (one part of the attribute data) that will be described later, i.e., determines for each pixel whether a photograph filter or a character filter should be employed. It should be noted that a coefficient for performing smoothing only for a high frequency element is designated for a photograph filter. This is done to prevent the roughness of an image from being outstanding. Further, a coefficient to perform edge enhancement is set for a character filter. This is done to better express the sharpness of a character.

A histogram generating section 503 performs the sampling of luminance data of the individual pixels that form received image data. More specifically, the histogram generating section 503 performs sampling, at constant pitches in the main scanning direction and the sub-scanning direction, of luminance data included in a rectangular area that is defined from the starting point to the ending point, designated in the main scanning direction and the sub-scanning direction, and generates histogram data based on the sampling results. Histogram data thus generated are employed when the level of an under color is to be estimated during the under color removal process. An input gamma correction section 504 performs a conversion by using, for example, a table, and obtains luminance data having a non-linear characteristic.

A color/monochrome determination section 505 determines whether each pixel constituting the received image data represents chromatic color or achromatic color, and attaches the determination results, as a color/monochrome determination signal (a part of attribute data), to image data.

A character/photograph determination section 506 employs the pixel value of each pixel constituting image data, and the pixel values of surrounding pixels of the pertinent pixel, to determine whether the pixel is a constituent of a character or not, or of a halftone dot or not, of a character in a halftone dot, or of a solid image. Or when a pixel does not fit into any of these categories, a pixel used to constitute a blank area. The character/photograph determination section 506 then attaches the determination results, as a character/photograph determination signal (a part of the attribute data), to image data.

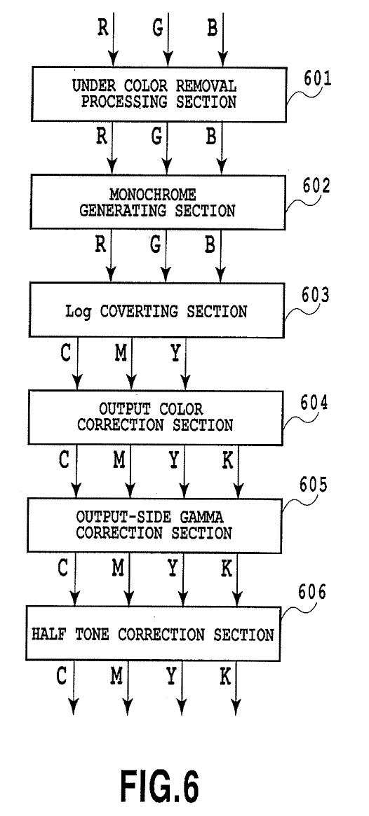

In this invention, a pixel constituting a halftone dot, or a pixel constituting a character in a halftone dot, or a pixel constituting a solid image is called a pixel having a photographic/graphic attribute, or a pixel whose attribute type is that of a photograph/graphics.

<Detailed Explanation of the Printer Image Processing Section 315 (FIG. 6)>

FIG. 6 is a diagram showing the processing performed by the printer image processing section 315.

An under color removal processing section 601 removes the under color of image data using the histogram generated by the scanner image processing section 312. A monochrome generating section 602 converts color data into monochrome data. A Log converting section 603 performs luminance/density conversion, e.g., converts input RGB image data into CMY image data. An output color correction section 604 performs output color correction, e.g., employs a table or a matrix to convert input CMY image data into CMYK image data. An output-side gamma correction section 605 performs corrections, so that a signal value input to the output-side gamma correction section 605 is proportional to a reflection density value after the duplicate is output. A half tone correction section 606 performs an arbitrary half tone process in consonance with the number of tones to be output by the printer unit 14. The half tone correction section 606 performs, for example, binarization or a quantization to 32-value processing for image data of high gradation values that is received.

The individual processors provided for the scanner image processing section 312 and the printer image processing section 315 can also output received image data, without performing any process. Hereinafter, an event wherein a specific processor passes data without performing any process is referred to as “permitting data to pass through a processing section”. This ends the explanation for the controller unit 11.

<Explanation of a Copying Operation and a PDL Printing Operation>

Next, a copying operation and a PDL printing operation will be explained while referring to FIGS. 2, 5 and 6.

First, the copying operation will be described. When a document is read by the scanner unit 13, the obtained data are transmitted as image data to the scanner image processing section 312 via the scanner I/F 311. The scanner image processing section 312 performs the processing shown in FIG. 5 for the image data, generates attribute data as well as new image data, and attaches the attribute data to the image data. Sequentially, the compression section 313 generates tile data by dividing the image data into blocks of 32×32 pixels, and further, compresses the image data consisting of multiple sets of tile data. The image data compressed by the compression section 313 are transmitted to and stored in the RAM 302. It should be noted that the image data are transmitted to the image converting section 317 as needed, and that after the image processing has been performed for the image data by the image converting section 317, the resultant data are transmitted to the RAM 302 and the image data are again stored in the RAM 302. Thereafter, the image data stored in the RAM 302 are transmitted to the expansion section 316. The expansion section 316 expands the image data, and then performs raster development for the expanded image data that consist of multiple sets of tile data. Then the image data obtained after raster development are transmitted to the printer image processing section 315, which edits the image data in consonance with the attribute data added to the image data. This processing is performed as shown in FIG. 6. And after the image data have been edited by the printer image processing section 315, the image data are transmitted to the printer unit 14 via the printer I/F 314. Finally, the printer unit 14 forms an image on a sheet.

The editing methods employed by the respective processing sections of the scanner image processing section 312 and the printer image processing section 315, i.e., the processing sections shown in FIGS. 5 and 6, are changed by switching between registers. These registers are switched in accordance with attribute information and setup information entered at the operating portion 12 (by a user). Furthermore, although not mentioned in the above explanation, the process for storing image data in the ROM 202 or on the HDD 304, or the process for extracting image data from the ROM 303 or the HDD 304, may naturally be performed, as needed.

The PDL operation will be sequentially described. PDL data received from the PC 40 via the LAN 50 are transmitted to the RAM 302 via the network I/F 306, and stored there. Intermediate data are generated by translating the PDL data stored in the RAM 302, and are transmitted to the RIP 328. The RIP 328 performs rendering for the received intermediate data, and generates image data having a raster form.

When PDL data, before being translated, are prepared by a specific application, object data are present in the PDL data. The term “object data” is a general term for character code data, bit map data, graphics data and filled data which constitute a document image (herein after also referred to original data). The PDL data that include the object data are changed to intermediate data, as described above, and rendering is performed for the intermediate data. At this time, a pixel value is generated for each pixel in the document image, and actually, attribute information is generated for each pixel in a document image. The attribute information is determined by examining the type of object data in each pixel area. That is, when object data corresponding to a specific pixel are character code, the attribute information for this pixel is “character”. Or, when object data corresponding to the other pixel are bitmap data, the attribute data for the pixel is “image”. When object data corresponding to the other pixel is graphics data, and a specific width or greater is obtained vertically and horizontally, the attribute information for the pixel is “graphics”. When object data for the other pixel are graphics data and a specific width or smaller is obtained either vertically or horizontally, the attribute information for this pixel is “line”.

The thus generated image data having a raster form are transmitted to the compression section 329, with attribute information. The compression section 329 divides the image data into blocks, compresses the image data and transmits the compressed image data to the RAM 302. It should be noted that the attribute information is naturally added to these image data. In a case wherein PDL printing is instructed, the image data are transmitted to the printer unit 14, and image forming is performed on an output sheet. Since this operation is the same as for the copying operation, no further explanation for it will be given.

A method for setting a copy-forgery-inhibited pattern will now be described.

<Explanation of an Operating Screen>

The initial screen and an operating screen displayed for setting a copy-forgery-inhibited pattern are shown in FIGS. 7, 8, 9 and 10.

FIG. 7 is a diagram showing the initial screen displayed in the image forming apparatus 10. An area 701 is used to indicate whether the image forming apparatus 10 is ready for copying, and also to indicate the designated number of copies. A document selection tab 704 is used to select a document type, and when this tab 704 is clicked on, a selection menu for three mode types, a character mode, a photograph mode and a character/photograph mode, pops up. A finishing tab 706 is used to perform a setup related to various finishing types. A double-sided setup tab 707 is used to perform a setup related to double-sided reading and double-sided printing. A reading mode tab 702 is used to select a document reading mode. When this tab 702 is clicked on, a selection menu for three types, color/black/automatic (ACS), pops up. When color is selected, color copying is performed, when black is selected, monochrome copying is performed, and when ACS is selected, a copying mode is determined in accordance with the above described monochrome color determination signal.

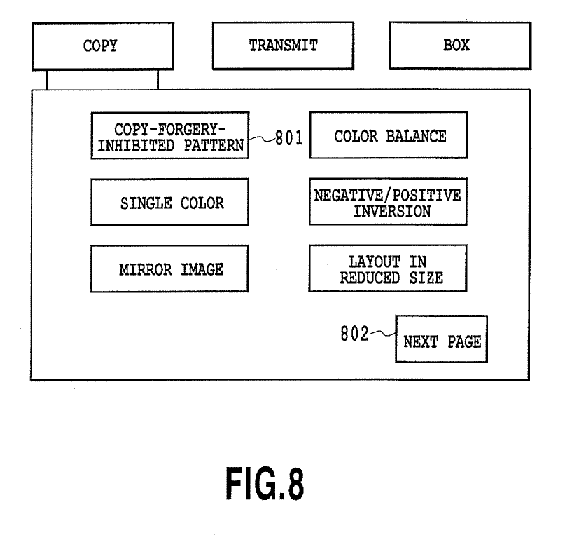

FIG. 8 is a diagram showing a screen displayed when an application mode tab 705 in FIG. 7 is clicked on. On this screen, a user can designate a reduced size layout, a color balance and a copy-forgery-inhibited pattern.

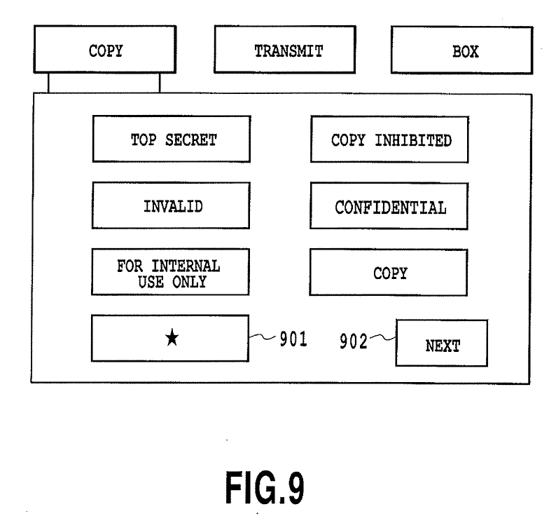

FIG. 9 is a diagram showing a screen displayed when a copy-forgery-inhibited pattern tab 801 in FIG. 8 is clicked on. On this screen, a user can set, as a latent-mark, character string information (for example, TOP SECRET, COPY INHIBITED, INVALID CONFIDENTIAL, FOR INTERNAL USE ONLY, COPY) or symbol information (for example, *). When the user selects the symbol information (*) as a latent-mark, the user need only click on a symbol information tab 901 and then click on a NEXT tab 902.

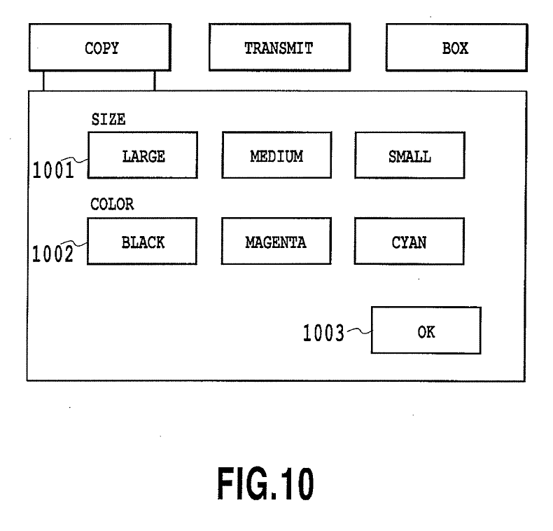

FIG. 10 is a diagram showing a screen displayed when the NEXT tab 902 in FIG. 9 is clicked on. On this screen, a user can set the font size and the color of a latent-mark. Large, medium and small choices 1001 are available for the font size, and black, magenta and cyan choices 1002 are available for the color. When the font and the color have been set and an OK tab 1003 is clicked on, the copy-forgery-inhibited pattern setup is completed.

<Image Forming Processing for Copy-forgery-inhibited Pattern-combined Image Data>

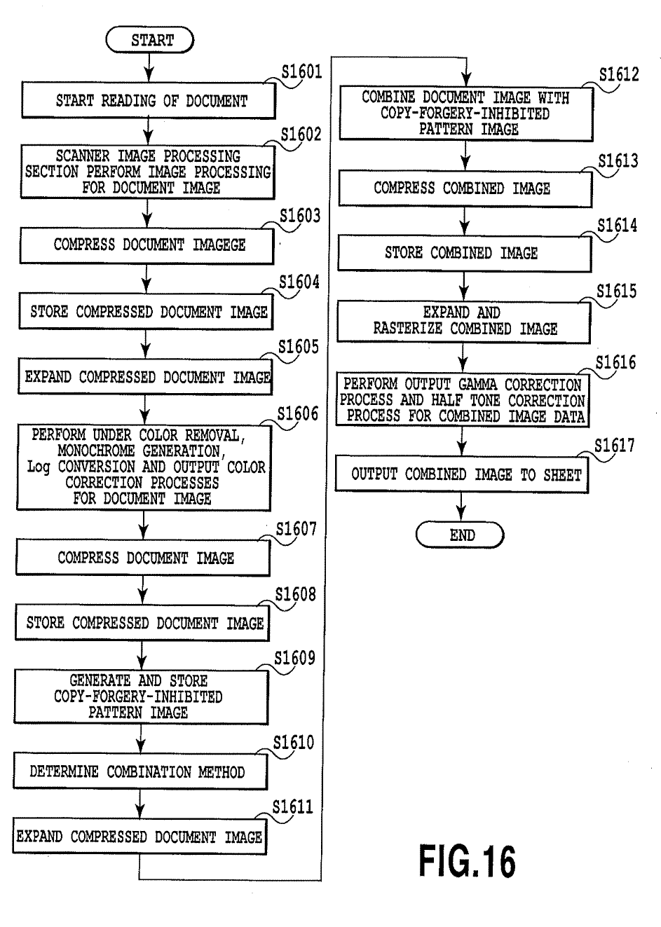

While referring to FIG. 16, an explanation will now be given for the processing for combining document image data obtained by reading a document and copy-forgery-inhibited pattern image data to generate a combined image, and for outputting the combined image on a sheet. It should be noted that the CPU 301 collectively controls the individual processes, and the RAM 302 serves as the main memory and the work area for the CPU 301.

When an instruction for combining a copy-forgery-inhibited pattern to a document is entered through the operating screens (FIGS. 8 to 10), the scanner unit 13 begins a document reading process (S1601). Document image data generated during the reading process are transmitted to the scanner image processing section 312, which then performs predetermined image processing (S1602). Further, as described above, each time this predetermined image processing is performed, attribute information is generated for each pixel (see the character/photograph determination section 506 in FIG. 5). After the predetermined image processing has been performed, the document image data are transmitted to and compressed by the compression section 313 (S1603). The compressed document image data are transmitted, with associated attribute data, to the RAM 302 and are stored there (S1604). It should be noted that the document image data stored in the RAM 302 consist of multiple sets of tile data. The above described processing is the same as the processing previously explained in <Copying operation>

Thereafter, the document image data stored in the RAM 302 are transmitted to the expansion section 318, which expands the document image data (S1605) and transmits the expanded document image data to the color space converting section 322. The color space converting section 322 performs the under color removal process, the monochrome generation process, the Log conversion process and the output color correction process for the document image data (S1606). These processes correspond to those performed by the under color removal processing section 601, the monochrome generating section 602, the Log converting section 603 and the output color correction section 604 in FIG. 6. After these processes have been performed, the document image data are transmitted to the compression section 319, which compresses the document image data for which the color space converting section 322 has performed the image processing (S1607). The compressed document image data are then transmitted to and stored in the RAM 302 (S1608). Copy-forgery-inhibited pattern image data, which are generated through a process that will be described later, are stored in the RAM 302 as uncompressed image data (S1609). It should be noted that the copy-forgery-inhibited pattern image data stored in the RAM 302, as well as the document image data, consist of multiple sets of tile data.

Sequentially, then, a method is determined for combining the document image data and the copy-forgery-inhibited pattern image data (S1610).

Following this, the document image data stored in the RAM 302 are transmitted to the expansion section 318, which expands the document image data (S1611) and transmits the expanded document image data to the synthesis section 327. In the same manner, the copy-forgery-inhibited pattern image data are transmitted via the expansion section 318 to the synthesis section 327. At this time, the expansion section 318 does not expand the copy-forgery-inhibited pattern image data, because originally, the copy-forgery-inhibited pattern image data are not compressed.

Through this processing, the document image data and the copy-forgery-inhibited pattern image data are transmitted to the synthesis section 327, and at this time, the synthesis method determined at S1610 is also transmitted. The synthesis section 327 combines the two sets of image data by employing the synthesis method determined at S1610 (S1612). Since the two sets of image data are formed of multiple sets of tile data, the combined image data also consist of multiple sets of tile data. The synthesis process at S1612 will be described later in detail. Then, the combined image data are transmitted to the compression section 319, where they are compressed (S1613). The compressed combined image data are then transmitted to and stored in the RAM 302 (S1614). Furthermore, the combined image data stored in the RAM 302 are transmitted to the expansion section 316, which expands the combined image data and performs rasterization for the expanded combined image data (S1615). Thereafter, the rasterized combined image data are output to the printer image processing section 315.

Sequentially, the printer image processing section 315 performs the output gamma correction process and the half tone correction process for the combined image data (S1616). These processes correspond to those performed by the output gamma correction section 605 and the half tone correction section 606 shown in FIG. 6. On the other hand, the under color removal process, the monochrome generating process, the Log converting process, and the output color correction process are not performed. At this time, these processes correspond to those performed by the under color removal processing section 601, the monochrome generating section 602, the Log converting section 603 and the output color correction section 604 in FIG. 6. These processes are not performed for the combined image data for avoiding the deterioration, due to the performance of these processes, of copy-forgery-inhibited pattern image. It should be noted that, as described above, these four processes have previously been performed for the document image data by the color space converting section 322.

After the above described processes have been performed by the printer image processing section 315, the combined image data are output to the printer unit 14 via the printer I/F 314. The printer unit 14 outputs the received combined image data to a sheet (S1617). That is, the printer unit 14 performs image forming for the combined image data used to print a sheet. And this completes the description of the image forming processing performed for a copy-forgery-inhibited pattern-combined image (a combined image).

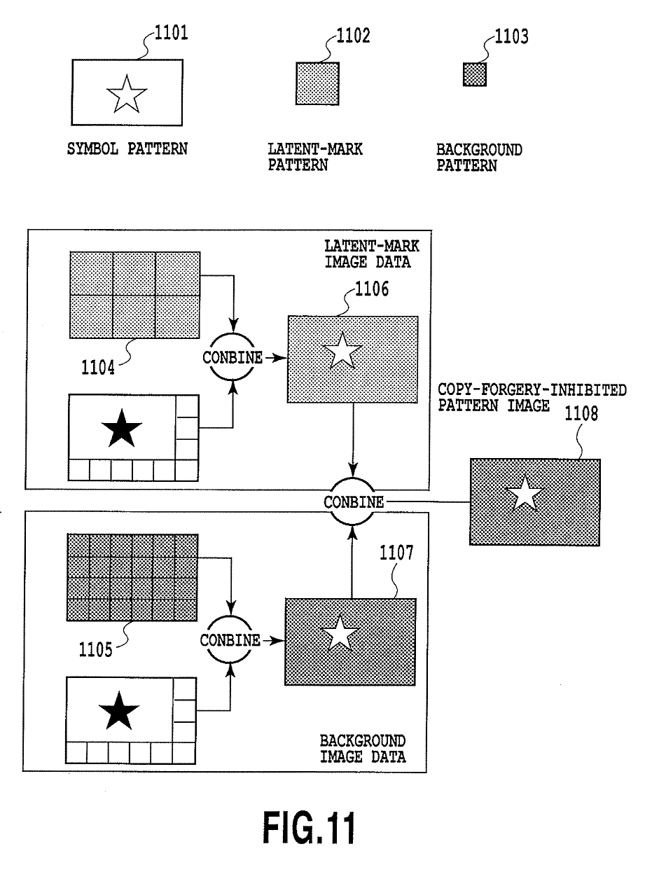

Furthermore, although not mentioned in the above explanation, the process for storing image data in the ROM 202 or on the HDD 304, or the process for extracting image data from the ROM 303 or the HDD 304, may naturally be performed, as needed.

<Processing for Generating Copy-forgery-inhibited Pattern Image Data (FIG. 11)>

The processing performed for the generation of copy-forgery-inhibited pattern image data will now be described while referring to FIG. 11.

First, bitmap data are generated based on information for a latent-mark (such as TOP SECRET, COPY INHIBITED or symbol information), designated by a user. A symbol pattern 1101 is a conceptual diagram for bitmap data generated based on symbol information.

Following this, a latent-mark pattern 1102 and a background pattern 1103 (both of which are bit map data) are generated by the performance of a dithering process.

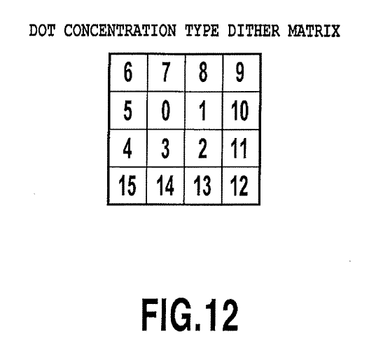

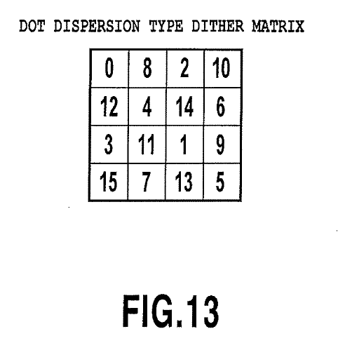

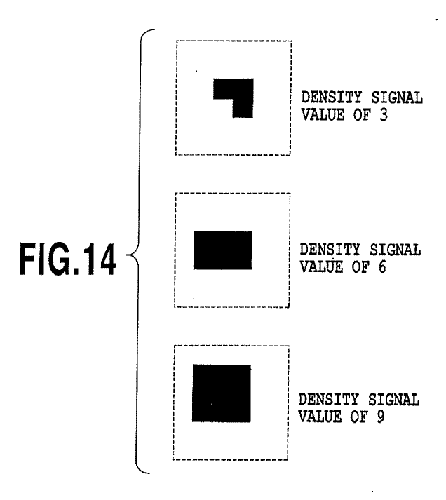

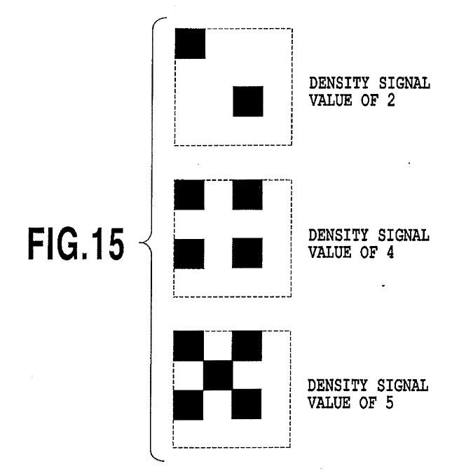

While referring to FIGS. 12 to 15, the dithering process, which is a well known technique, will be briefly described by employing an example (FIGS. 12 and 13) wherein a 4×4 dither matrix is employed both for a dot concentration type and a dot dispersion type. FIG. 14 is a diagram showing a dot pattern generated by applying density signal values 3, 6 and 9 for a dot concentration type dither matrix shown in FIG. 12. When the dither matrixes in FIGS. 12 and 14 are compared, it is found that in the dot concentration type dither matrix (FIG. 12), dots are formed (ON) at pixel positions where values are equal to or smaller than the density signal values. Similarly, FIG. 15 is a diagram showing a dot pattern generated by applying density signal values 2, 4 and 5 for a dot dispersion type dither matrix shown in FIG. 13. When the dither matrixes in FIGS. 14 and 15 are compared, it is found that the dot pattern in FIG. 14 is a concentration type, while the dot pattern in FIG. 15 is a dispersion type.

The dithering process has been explained, and an explanation will now again be given for the processing for generating the latent-mark pattern 1102 and the background pattern 1103.

A dither matrix for generating a latent-mark portion (hereafter referred to as a latent-mark matrix) and a density signal value for latent-mark portion generation, which is applied for the latent-mark matrix, are stored on the HDD 304. Also, a dither matrix for generating a background portion (hereinafter referred to as a background matrix) and a density signal value for background portion generation, which is applied for the background matrix, are stored on the HDD 304.

For the generation of the latent-mark pattern 1102, the latent-mark matrix and the density signal value for latent-mark portion generation are read from the HDD 304. Then, the density signal value for latent-mark portion generation is applied for the latent-mark matrix, and the latent-mark pattern 1102 is generated. The background pattern 1103 is generated in the same manner.

Sequentially, patterns (called a latent-mark repetitive pattern 1104 and a background repetitive pattern 1105) are generated by repeating the latent-mark pattern 1102 and the background pattern 1103 a predetermined number of times. Thereafter, the latent-mark repetitive pattern 1104 and the symbol pattern 1101 are employed to generate latent-mark data 1106. Background image data 1107 are generated in the same manner. Then, the latent-mark data 1106 and the background image data 1107 are combined to generate copy-forgery-inhibited pattern image data 1108. The thus obtained copy-forgery-inhibited pattern image data 1108 are binary bitmap data, to which, it should be noted, color information for C, M or K is attached. This color information may be determined by employing a user setup or may be based on color information for the document image data.

As described above, in this embodiment, copy-forgery-inhibited pattern image data are generated through a dithering process. However, the present invention is not limited to this method, and the error diffusion method or the average density method, for example, may be employed to create a background pattern.

<Detailed Explanation for Synthesis Method Determination Process 1 (S1610)>

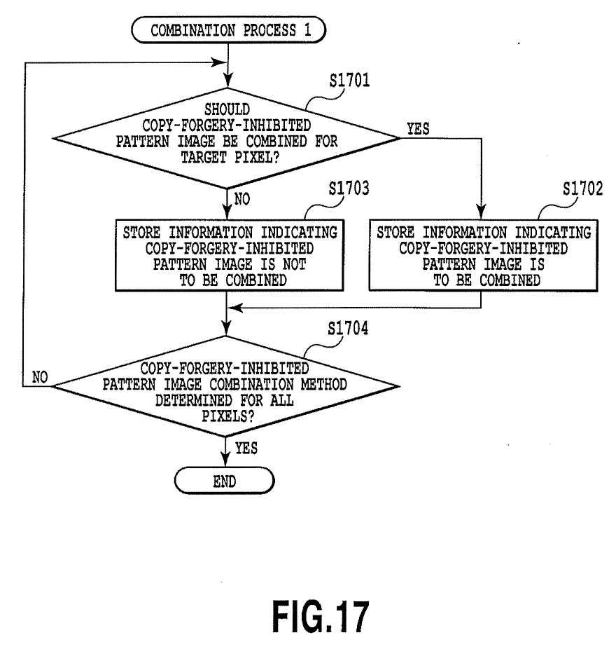

While referring to FIG. 17, an explanation will be given for the process at S1610 for determining a method for combining document image data and copy-forgery-inhibited pattern image data. The CPU 301 collectively controls the individual processes, while the RAM 302 serves as the main memory or the work area for the CPU 301.

At S1701, a check is performed to determine whether a copy-forgery-inhibited pattern image should be combined for an object pixel that is currently a processing object. Here, a pixel for which a copy-forgery-inhibited pattern image should be combined is defined as a pixel that does not have a photographic/graphics attribute, and a pixel for which a copy-forgery-inhibited pattern image should not be combined is defined as a pixel that has a photographic/graphics attribute. When the attribute for the process object pixel is a photographic/graphics attribute, program control advances to S1703. When the attribute is not a photograph/graphics attribute, program control is shifted to S1702. In this manner, since a copy-forgery-inhibited pattern image is not combined for an area having a photographic/graphics attribute, deterioration of the image quality in that area can be prevented. And since a copy-forgery-inhibited pattern image is combined for the other area, a document image can be output that provides copy prevention effects.

At S1703, information indicating the object pixel is a pixel for which a copy-forgery-inhibited pattern image is not to be combined is stored in the RAM 302.

At S1702, information indicating the target pixel is a pixel for which a copy-forgery-inhibited pattern image is to be combined is stored in the RAM 302.

At S1704, a check is performed to determine whether the processes at S1702 and S1703 have been performed for all the pixels, i.e., whether all the pixels of the document image are regarded as object pixels. When it is determined that the processes have been completed for all the pixels, the processing in FIG. 17 is terminated. When it is determined that the processes have not yet been completed for all the pixels, program control returns to S1701 and the above described processing is performed with a new pixel as the processing object.

<Detailed Explanation for Synthesis Process 1 (S1612)>

When, at S1610, an area wherein a copy-forgery-inhibited pattern image should be combined and an area wherein a copy-forgery-inhibited pattern image should not be combined are determined, a copy-forgery-inhibited pattern image reflecting this determination is generated at S1612.

First, pixels are read for which it has been determined, at S1701, that the copy-forgery-inhibited pattern image should be combined.

For a pixel for which it has been determined that the copy-forgery-inhibited pattern image should be combined, the value of an object pixel in the document image is compared with the value of an object pixel in the copy-forgery-inhibited pattern image, and the value that is not the smaller (the density value is not small) is determined to be the pixel value for a combined image (determined to be a logical sum synthesis). However, the synthesis method of the invention is not limited to the logical sum synthesis, and may be an overwriting synthesis of a copy-forgery-inhibited pattern image.

When the overwriting synthesis of a copy-forgery-inhibited pattern image and a document image is employed, and when an object pixel in a copy-forgery-inhibited pattern image is white, the pixel value of the object pixel in a combined image should be equal to the pixel value of the object pixel in a document image. Further, when the pixel value in a copy-forgery-inhibited pattern image is other than white, the pixel value of the object pixel in a combined image should be equal to the pixel value of the object pixel in a copy-forgery-inhibited pattern image.

While taking this into account, when the overwriting synthesis is compared with the logical sum synthesis, the pixel value of the copy-forgery-inhibited pattern image is presented more effectively to the combined image by using the overwriting synthesis. Therefore, a merit of the overwriting synthesis is that a less deteriorated copy-forgery-inhibited pattern image is combined with a document image. However, as a demerit, because the less deteriorated copy-forgery-inhibited pattern image is combined, the image quality of the document image is reduced.

As for a pixel for which a copy-forgery-inhibited pattern image should not be combined, the pixel value in a document image is not changed. In this manner, the process is performed for the pixel for which a copy-forgery-inhibited pattern image should be combined, and the pixel for which a copy-forgery-inhibited pattern image should not be combined. When the process has been completed for all the pixels, the processing of S1612 is terminated, i.e., the combined image is generated.

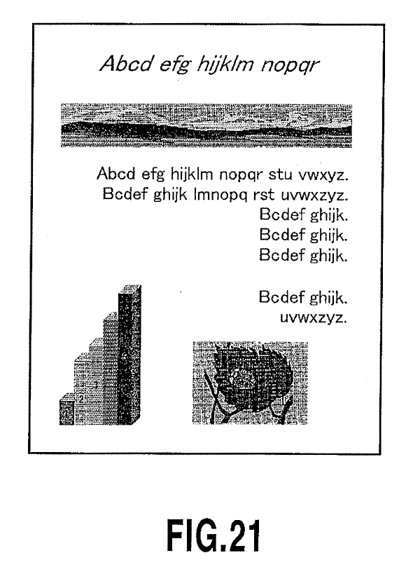

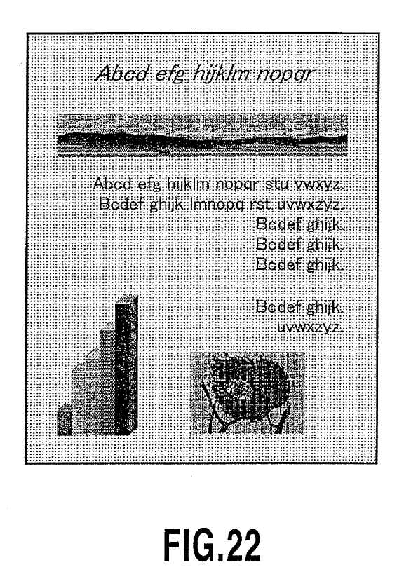

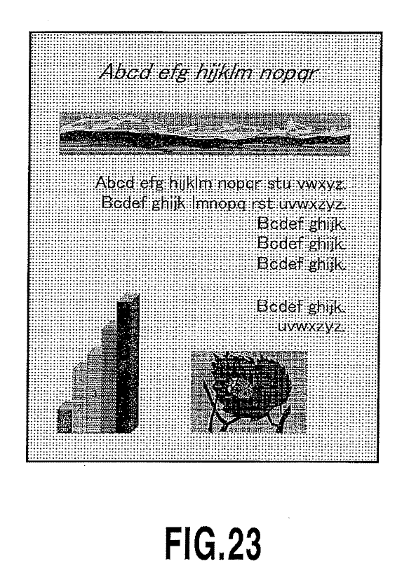

Next, while referring to FIGS. 21, 22 and 23, an explanation will be given for the effects obtained when a copy-forgery-inhibited pattern image is combined with a document image by using a synthesis method determined using the above described synthesis method determination process. FIG. 21 is a diagram showing a document image, and FIG. 22 is a diagram showing an image obtained simply by combining a copy-forgery-inhibited pattern image and a document image. FIG. 23 is a diagram showing a combined image obtained when a copy-forgery-inhibited pattern image is combined with a document image using a synthesis method determined using the above described synthesis method determination process. When the images in FIGS. 22 and 23 are compared, a copy-forgery-inhibited pattern image is combined with the entire area in FIG. 22, while in FIG. 23, a copy-forgery-inhibited pattern image is not combined with an area having a graphics attribute and an area having an image attribute. Therefore, for the combined image shown in FIG. 23, the image quality is not deteriorated in the area having the graphics attribute and the area having the image attribute.

<Detailed Explanation of Synthesis Method Determination Process 2 (S1610)>

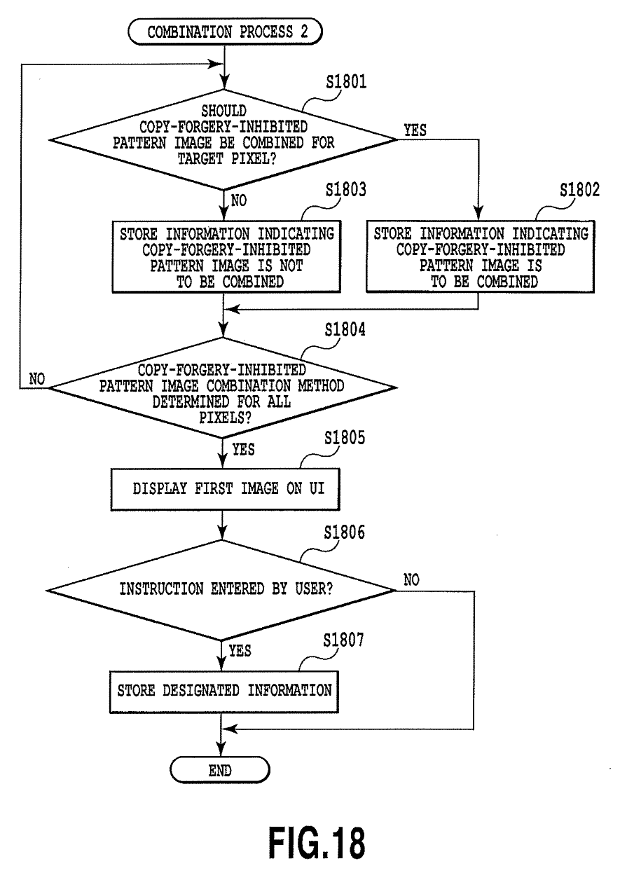

FIG. 18 is a flowchart showing another example of the synthesis method determination process (S1610) of the present invention. In this example, an area of a document image, for which a copy-forgery-inhibited pattern image should be combined, is determined as in <detailed explanation for synthesis process 1>, and the determination results are displayed as a preview. That is, the determination results are displayed on the screen, so that a user can identify an area in a document image for which a copy-forgery-inhibited pattern image is to be combined, and an area for which the copy-forgery-inhibited pattern image is not to be combined. At the same time, on this screen, the area for which a copy-forgery-inhibited pattern image is to be combined (or the area for which a copy-forgery-inhibited pattern image is not to be combined) can be changed in accordance with an instruction entered by a user. Since the area can be changed, printed matter can be prepared, while the user takes into account both an improvement in the copying prevention effects and the prevention of image quality deterioration.

Since the processes performed at S1801 to S1804 are the same as those at S1701 to S1704, no further explanation for them will be given.

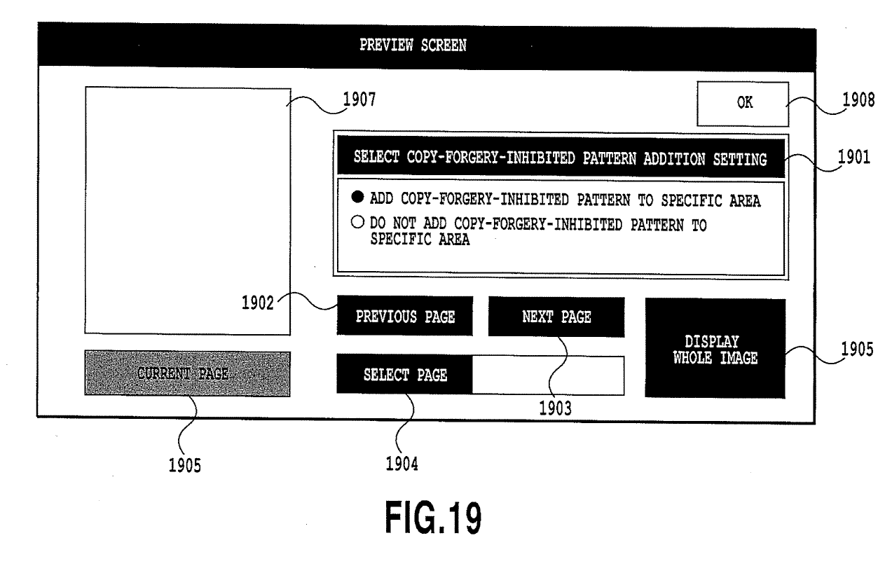

At step S1805, a first image is displayed on the operating screen of the operating portion 12, so that a user can identify an area, in a document image, for which the copy-forgery-inhibited pattern image should be combined, and an area for which the copy-forgery-inhibited pattern image should not be combined. At the same time, on this screen, an instruction from the user is accepted for changing a pattern synthesis area. A screen shown in FIG. 19 can be employed as an example display screen (the screen in FIG. 19 will be described later in detail). The first image for this embodiment is an image such as is prepared by providing a predetermined color for only an area of a document image, for which the copy-forgery-inhibited pattern image is to be combined, and by not providing any color for the other area. However, the first image used for this invention is not limited to this example. For example, a frame is provided only for an area of a document image for which a copy-forgery-inhibited pattern image is to be combined, and the thus prepared image may be defined as the first image. Or, a combined image obtained by combining two images using the synthesis method determined at step S1802 or S1803 may be employed as the first image.

At S1806, a check is performed to determine whether an area selection instruction has been entered by the user (such an instruction will be described later). When an area selection instruction has been entered, program control advances to S1807. And when an area selection instruction has not been entered, the processing in FIG. 18 is terminated.

At S1807, information indicating the selected area is stored in the RAM 302 with information indicating that the selected area is either an area for which the copy-forgery-inhibited pattern image should be combined, or an area for which the copy-forgery-inhibited pattern image should not be combined.

Next, example processes performed at S1805 and S1806 will be described. In FIG. 19, a copy-forgery-inhibited pattern addition setting area 1901 is used to allow a user to select either “add a copy-forgery-inhibited pattern to a specific area” or “do not add a copy-forgery-inhibited pattern to a specific area”. A tab 1902 is used when a user selects the first image of the page preceding of a page currently being previewed in order for it to be displayed in a preview area 1907. A tab 1903 is used when a user selects the first image of the page succeeding a page currently being previewed in order for it to be displayed in the preview area 1907. A tab 1904 is used to select a page to be displayed as the first image in the preview area 1907. An area 1905 is used to display a current object page. A tab 1906 is used to display the first image of the entire pages (or the first image for the number of pages available for display on the operating screen). The preview area 1907 is used to display the first image of a designated page, and in the preview area 1907, a position entered by a user at the operating portion 12 can be accepted. For example, when the user designates a first position and a second position on the preview area 1907, a rectangular area, in which the first and the second positions are connected to form a diagonal line, is selected.

When the user has selected “add a copy-forgery-inhibited pattern to a specific area” in the copy-forgery-inhibited pattern addition setting area 1901, and has selected an area in the preview area 1907, the selected area is established as an area for which a copy-forgery-inhibited pattern image should be combined. Then, this area designation result is presented in the first image (also called a second combined image) displayed in the preview area 1907. Specifically, for example, a color is provided (a frame is provided, or a copy-forgery-inhibited pattern image is combined with) for the area selected in the preview area 1907. The display for the area, for which a position designation is not made in the preview area 1907, is unchanged.

On the other hand, when the user has selected “do not add a pattern to a specific area” in the area 1901, and has selected an area in the preview area 1907, the selected area is established as an area for which a copy-forgery-inhibited pattern image should not be combined. Then, the area selection result is presented in the first image displayed in the preview area 1907. Specifically, for example, the frame enclosing the part of the selected area is erased, the color of the colored part is removed, or a copy-forgery-inhibited pattern image is removed from the portion wherein the copy-forgery-inhibited pattern image has been combined. As a result, the area selection result is presented in the first image. Of course, the display of the area for which area selection in the preview area 1907 is not affected is unchanged.

An OK tab 1908 is used to establish an area for which a copy-forgery-inhibited pattern image should be combined and an area for which a copy-forgery-inhibited pattern image should not be combined. When the OK tab 1908 is clicked on, the process of S1806 is initiated. That is, before the OK tab 1908 is clicked on, a check is performed to determine whether an area for which a copy-forgery-inhibited pattern image should (or should not) be combined has been designated, based on an instruction entered by the user.

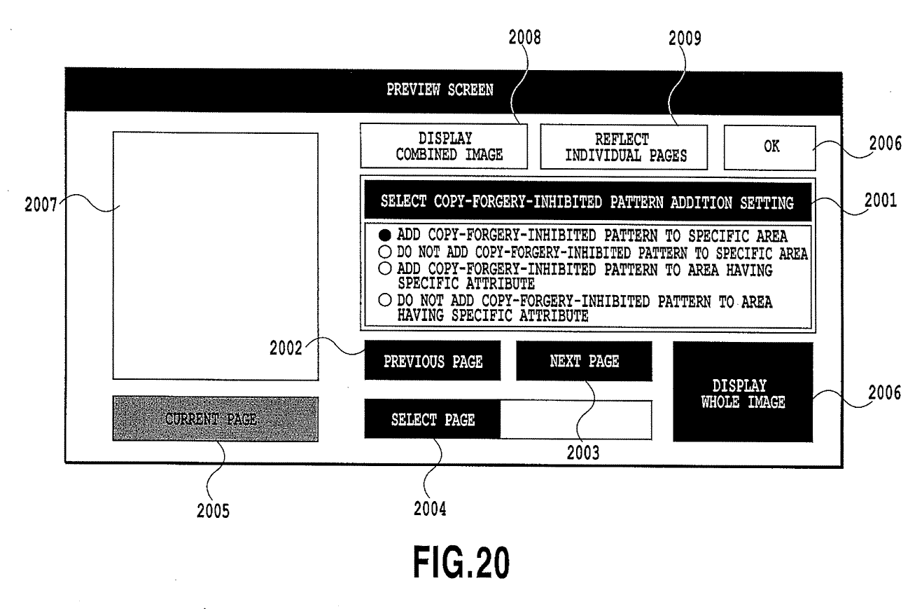

The process at S1805 has been explained on the assumption that the screen in FIG. 19 is displayed. However, the screen to be displayed for the process at S1805 is not limited to this example. Any other screen can be displayed so long as a user can identify, on the screen, an area for which a copy-forgery-inhibited pattern image should be combined and an area for which a copy-forgery-inhibited pattern image should not be combined, and can change these areas. As another example, a screen shown in FIG. 20 can be employed.

The differences between the screen in FIG. 20 and the screen in FIG. 19 are a copy-forgery-inhibited pattern addition setting area 2001, a display setting area 2008 and an effectiveness setting area 2009.

The copy-forgery-inhibited pattern addition setting area 2001 is used to allow a user to select “add a copy-forgery-inhibited pattern to a specific area”, “do not add a copy-forgery-inhibited pattern to a specific area”, “add a copy-forgery-inhibited pattern to an area having a specific attribute” or “do not add a copy-forgery-inhibited pattern to an area having a specific attribute”.

The display setting area 2008 is used to selecting displays of combined images, and “display a combined image” is displayed as a default of this area. When the display setting area 2008 is clicked on, the display is changed to “display by individual attributes”. When “display a combined image” is selected, the first image is displayed in a preview area 2007. And when “display by individual attributes” is selected, the second image is displayed in the preview area 2007. This second image is the one obtained by coloring the individual areas of the document image in consonance with the attributes. For example, different colors are provided for pixels that form characters, pixels that form halftone dots, pixels that form characters in halftone dots, pixels that form a solid image and other pixels, so that the second image is generated. However, the second image of this invention is not limited to this example, and individual areas of a document image may be enclosed, consonant with the attributes, by color frames to generate the second image.

The effectiveness setting area 2009 is used to selecting pages for which the copy-forgery-inhibited pattern addition setting is made effective, and “affect individual pages” is made effective and displayed as a default. Then, when the effectiveness setting area 2009 is clicked on, the display is changed to “affect all pages”. When “affect individual pages” is selected, an instruction entered in the pattern addition setting area 2001 affects only the current page. And when “affect all pages” is selected, an instruction entered in the pattern addition setting area 2001 affects all the pages.

Assume that the user has selected “add a pattern to an area having a specific attribute” in the pattern addition setting area 2001, and uses a pointing device (not shown) to select the position in the preview area 1907 of a pixel that forms a solid image. Then, the setting is made so that a copy-forgery-inhibited pattern is combined to all the pixels that form a solid image. Thereafter, this setup is made effective for the first image, and then the pixels that form the solid image are colored, or are enclosed by frames.

At this time, when “affect individual pages” is selected in the effectiveness setting area 2009, the setting is made so that a copy-forgery-inhibited pattern is to be combined to the pixels in a current page that form a solid image. When “affect all pages” is selected in the effectiveness setting area 2009, the setting is made so that a copy-forgery-inhibited pattern is to be combined to the pixels of all the pages that form solid images.

As described above, through the user selects “add a pattern to an area having a specific attribute” in the pattern addition setting area 2001, and designates the pixel position in the preview area 1907, the user can choose a specific attribute type. As a result, the user can issue an instruction to add a copy-forgery-inhibited pattern image to all the pixels that have this specific attribute. When “do not add a pattern to an area having a specific attribute” is selected, this means that the opposite instruction is entered.

When the user uses the UI in FIG. 20, unlike when using the UI in FIG. 19, the user can determine the addition of a pattern for many more attributes. That is, the user can designate a copy-forgery-inhibited pattern addition for many more attribute choices (more choices than either a photographic/graphics attribute or not), such as a pixel that forms a character, a pixel that forms a halftone dot, a pixel that forms a character in a halftone dot, a pixel that forms a solid image, and other pixels. Further, since the preview can also be provided by respectively changing the display for these attributes, the user can identify an area with an attribute, while designating the addition of a copy-forgery-inhibited pattern. Furthermore, since “affect all pages” is also selectable, the number of times the pattern addition setting operation is performed can be reduced.

<Detailed Explanation for Synthesis Process 2 (S1612)>

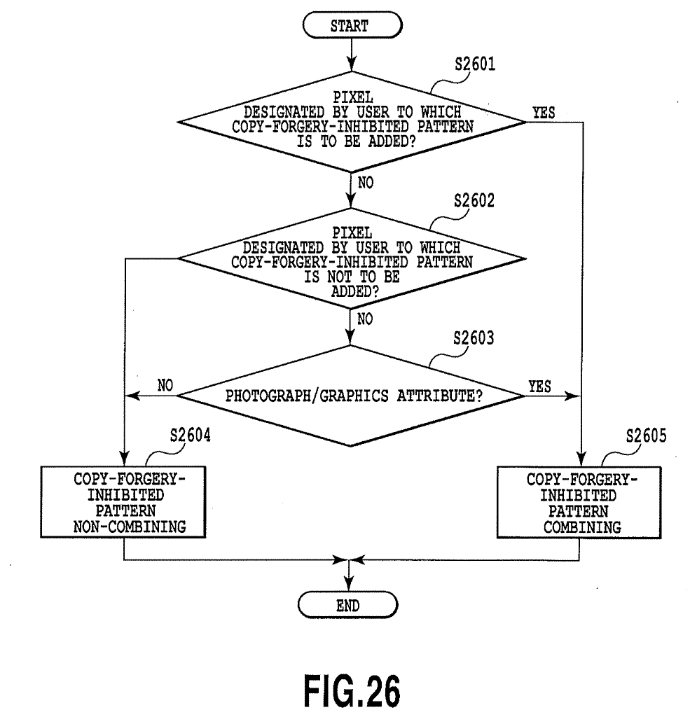

When, at S1610, as described above, an area for which a copy-forgery-inhibited pattern image should be combined and an area for which a copy-forgery-inhibited pattern image should not be combined are determined, and a selection by the user is established, a copy-forgery-inhibited pattern image presenting these determinations is generated at S1612. FIG. 26 is a flowchart for explaining the process at S1612.

First, at S2601, a check is performed to determine whether an object pixel is a pixel for which a user has designated the addition of a copy-forgery-inhibited pattern. When the object pixel is one for which the addition of the copy-forgery-inhibited pattern has been designated, program control is shifted to S2605. When the object pixel is not a pixel for which the addition of the copy-forgery-inhibited pattern has been designated, program control advances to S2602.

At S2602, a check is performed to determine whether the object pixel is a pixel for which no copy-forgery-inhibited pattern addition has been designated by the user. When the object pixel is a pixel for which no copy-forgery-inhibited pattern addition has been designated, program control is shifted to S2604. When the object pixel is not a pixel for which no copy-forgery-inhibited pattern addition has been designated, program control advances to step S2603.

At S2603, a check is performed to determine whether the object pixel is a pixel having a photographic/graphics attribute. When the object pixel is a pixel having a photographic/graphics attribute, program control is shifted to S2605. When the target pixel is not a pixel having a photographic/graphics attribute, program control is shifted to S2604.

At S2604, the pixel value of the object pixel in the document image is defined as the pixel value of the target pixel in a combined image.

At S2605, the pixel value of the object pixel in the copy-forgery-inhibited pattern image is compared with the pixel value of the object pixel in the document image, and the greater value is defined as the pixel value of the object pixel in a combined image (local sum synthesis).

The processing in FIG. 26 has been explained, and at S2605, the logical sum synthesis method has been employed; however, in this invention, the method for defining the pixel value of the target pixel in the combined image at S2605 is not limited to the one described here. For example, the above described overwriting synthesis method may be employed.

As described above, in the synthesis method determination process 2 and the synthesis process 2, the pixel value of the target pixel in the combined image is determined by using the flowcharts in FIGS. 18 and 26. However, the present invention is not limited to these processes.

For example, at S1806, a check may be performed to determine whether a user has entered a copy-forgery-inhibited pattern addition instruction or a copy-forgery-inhibited pattern non-addition instruction. When it is determined at S1807 that the copy-forgery-inhibited pattern addition instruction has been entered by the user, predetermined attribute information may be designated for that area, or when it is determined that the copy-forgery-inhibited pattern non-addition instruction has been entered, information other than the predetermined attribute information may be designated for that area. In this case, the determination processes at S2601 and S2602 are not required.

### SECOND EMBODIMENT

The first embodiment of the invention has been explained based on the assumption that a copy-forgery-inhibited pattern image is combined with a document image obtained by scanning. However, the present invention is not limited to this embodiment. For example, the present invention can also be applied for a system that combines a copy-forgery-inhibited pattern image with a document image having a PDL data form that is transmitted by a host computer 40. At this time, whether a copy-forgery-inhibited pattern image should be combined is determined in accordance with attribute information that is obtained for the individual pixels during a process for performing rendering for the document image having the PDL data form.

As described above, when rendering is performed for document image of a PDL data form, attribute information types, such as “picture”, “graphics”, “line” and “character”, are obtained for the individual pixels. Therefore, a pixel for which attribute information indicates “picture” or “graphics” is regarded as having a photographic/graphics attribute, and it is determined that a copy-forgery-inhibited pattern image should not be combined (S1703 or S1803). A pixel whose attribute information indicates “line” or “character” is regarded as not having a photographic/graphics attribute, and it is determined that a copy-forgery-inhibited pattern image should be combined (S1702 or S1802). For a pixel whose attribute information indicates “others”, i.e., a pixel in an area in which originally an object was not present, it is determined that a copy-forgery-inhibited pattern image should be combined (S1702 or S1802).

It should be noted that the attribute for each pixel, which is obtained by rendering a document image having a PDL data form, is determined in accordance with the type of object data to which the pertinent pixel belonged before the rendering process was performed.

### OTHER EMBODIMENTS

In the first embodiment, the pixel values of a copy-forgery-inhibited pattern image and of a document image have been employed for the generation of a combined image. However, the present invention is not limited to the use of a pixel value, and information representing the density or brightness of an image may also be employed. Information indicating the density or brightness of an image is generically referred to as a pixel value, and this pixel value also includes a density value and a luminance value.

In the first embodiment, a combined image was generated using a copy-forgery-inhibited pattern image and a document image. However, for the present invention, an image to be combined with a document image is not limited to a copy-forgery-inhibited pattern image, and any other image may be employed, e.g., an electronic watermark image or a form image may also be employed.

The following third, fourth, fifth and other embodiments relate to configurations for automatically adding (combining) a copy-forgery-inhibited pattern image to a printed image.

### THIRD EMBODIMENT

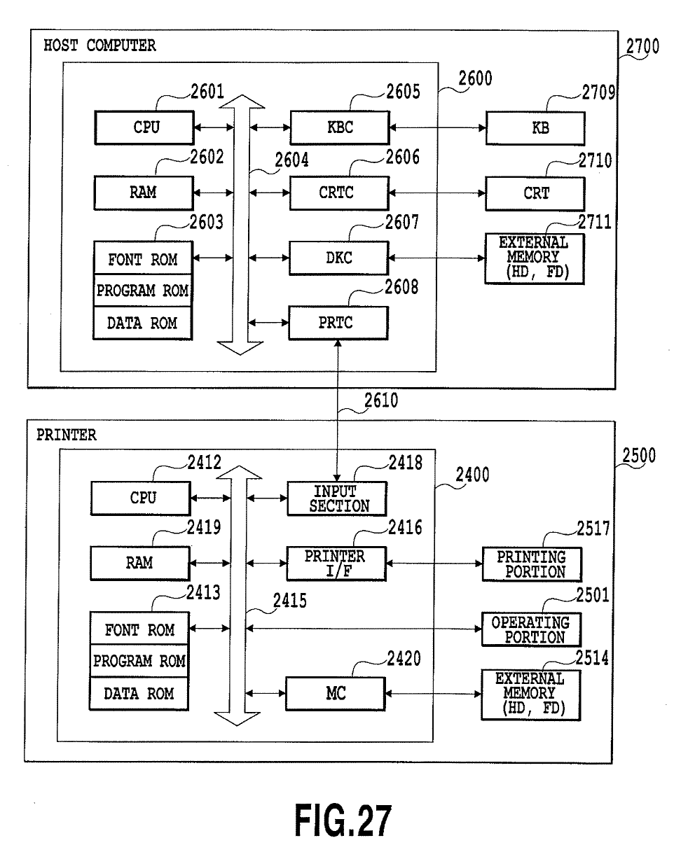

FIG. 27 is a block diagram showing the configuration of a printer control system according to the third embodiment of the present invention. So long as the functions of this invention are performed, the present invention can be applied for a single apparatus, a system constituted by a plurality of apparatuses, or a system with which processing is performed by accessing the system via a network, such as a LAN or a WAN.

In FIG. 27, a host computer 2700 includes a CPU 2601 that performs processing in accordance with a program ROM in a ROM 2603, or based on a document processing program stored in an external memory 2711. The CPU 2601 especially performs document processing, for documents in which there are graphics, pictures, characters and tables (including calculation tables), including a pattern printing process related to this embodiment that will be described later, and associated printing processing. Further, the CPU 2601 collectively controls the devices connected to a system bus 2604. An operating system (hereinafter referred to as an OS), which is the control program for the CPU 2601, is stored in the program ROM of the ROM 2603 or in the external memory 2711. Font data used for the document process are stored in the font ROM of the ROM 2603 or in the external memory 2711, and various other types of data used for the document process are stored in the data ROM of the ROM 2603 or the external memory 2711. A RAM 2603 is used as the main memory or the work area for the CPU 2601.

A keyboard controller (KBC) controls the entry of a key via a keyboard (KB) 2709 or a pointing device (not shown). A CRT controller (CTRC) 2606 controls a display for a CRT display (CRT) 2710. A disk controller (DKC) 2607 controls the access to a hard disk (HD) on which, for example, a boot program, various applications, font data, a user file, an editing file and a printer control command generation program (hereinafter referred to as a printer driver) are stored. The disk controller 2607 also controls the access to the external memory 11, such as a floppy (trademark) disk (FD). And a printer controller (PRTC) 2608 is connected to a printer 2500, via a bidirectional interface 2610, to provide communication with the printer 2500.

The CPU 2601 can develop (rasterize) an outline font to, for example, a display information RAM that is set in the RAM 2602 to enable “WYSIWYG” editing on the CRT 2710. Further, the CPU 2601 opens various windows that are registered based on commands entered using a cursor on the CRT 2710, and performs various data processes. For printing, the user opens a printing setup window to set up a printer or to select a printing method for a printer driver, to include a printing mode.

The printer 2500 is controlled by a CPU 2412. The CPU 2412 employs a control program stored in the program ROM of the ROM 2413, or stored in an external memory 2514, and outputs an image signal, as print information, to a printing portion (a printer engine) 2517 that is connected to the system bus 2415. A control program for the CPU 2412 is also stored in the program ROM of the ROM 2413. Font data used for the generation of the print information are stored in the font ROM of the ROM 2413. When a printer that does not include the external memory 2415, such as a hard disk, is employed, information used by a host computer is stored in the data ROM of the ROM 2413.

The CPU 2412 can communicate with the host computer via an input section 2418, and can transmit information of the printer 2500 to the host computer 2700. A RAM 2419 is a memory that serves as the main memory or the work area for the CPU 2412, and the memory capacity can be extended by an optional RAM that is connected to an extension port (not shown). The RAM 2419 is used as an output information development area, an environmental data storage area or an NVRAM. A memory controller 2420 controls the access to the external memory 2514, such as a hard disk (HD) or an IC card. The external memory 2514 is connected as an option, and is used to store font data, an emulation program and form data. Operating switches and an LED display device are provided for the input section 2418. The external memory 2514 is not limited to a single unit, and several optional cards or external memories may be connected, in which are stored not only incorporated font data but also a program that translates different types of printer control languages. Further, an NVRAM (not shown) may be provided for storing printer mode setup information that is received from an operating portion 2501. In this embodiment, the printing portion 2517 includes an electrophotographic engine, whereby an image and a copy-forgery-inhibited pattern image are printed by forming toner dots in accordance with print data. It should be noted that the printing method of the invention is not limited to the electrophotographic system. The present invention can also be applied for other printing systems, such as inkjet printing, that performs printing by forming dots.

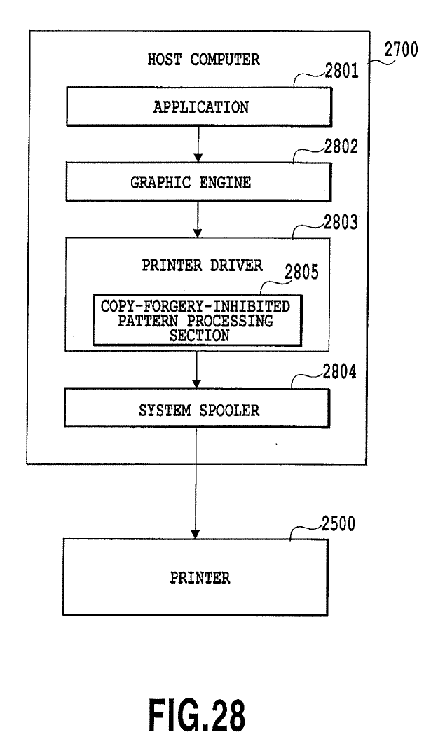

FIG. 28 is a block diagram showing an example configuration for the host computer 2700 in FIG. 27 for performing the printing processing. An application 2801, a graphic engine 2802, a printer driver 2803 and a system spooler 2804 are present as files stored in the external memory 2711. These are program modules that are to be loaded into the RAM 2602 and executed by an OS or another module that employs these modules. The application 2801 and the printer driver 2803 can be additionally provided for an FD or a CD-ROM (not shown) that serves as the external memory 2711, or can be additionally provided via a network (not shown) for an HD that also serves as the external memory 2711. The application 2801 stored in the external memory 2711 is loaded into the RAM 2602 and is executed. When the application 2801 allows the printer 2500 to perform printing, the graphic engine 2802, which has been also loaded in the RAM 2602 to be ready for execution, is employed to output (draw) data.

The graphic engine 2802 loads, from the external memory 2711 to the RAM 2602, the printer drier 2803 that is prepared for each printing apparatus, such as a printer, and sets the output of the application 2801 for the printer driver 2803. The graphic engine 2802 converts a GDI (Graphic Device Interface) function received from the application 2801 into a DDI (Device Driver Interface) function, and outputs the DDI function to the printer driver 2803. The printer driver 2803 performs conversions, based on the DDI function, for data received from the graphic engine 2802, and obtains a printer control command, such as a PDL (Page Description Language) command, that the printer can recognize. The thus obtained printer control command is transmitted by the OS via the system spooler 2804, which is loaded in the RAM 2602, and is further output via the bidirectional interface 2610, as print data to the printer 2500.

In the printing system of this embodiment, a copy-forgery-inhibited pattern processing section 2805 is included in the printer drier 2803. The copy-forgery-inhibited pattern processing section 2805 may be a built-in module for the printer driver 2803, or a library module to be added through a separate installation. The printer driver 2803 performs a copy-forgery-inhibited pattern image drawing process as the copy-forgery-inhibited pattern processing section 2805 initiates the printing of a copy-forgery-inhibited pattern image.

For an image processing system having the above described configuration, an explanation will now be given for the processing performed for the printing of a copy-forgery-inhibited pattern image according to this embodiment.

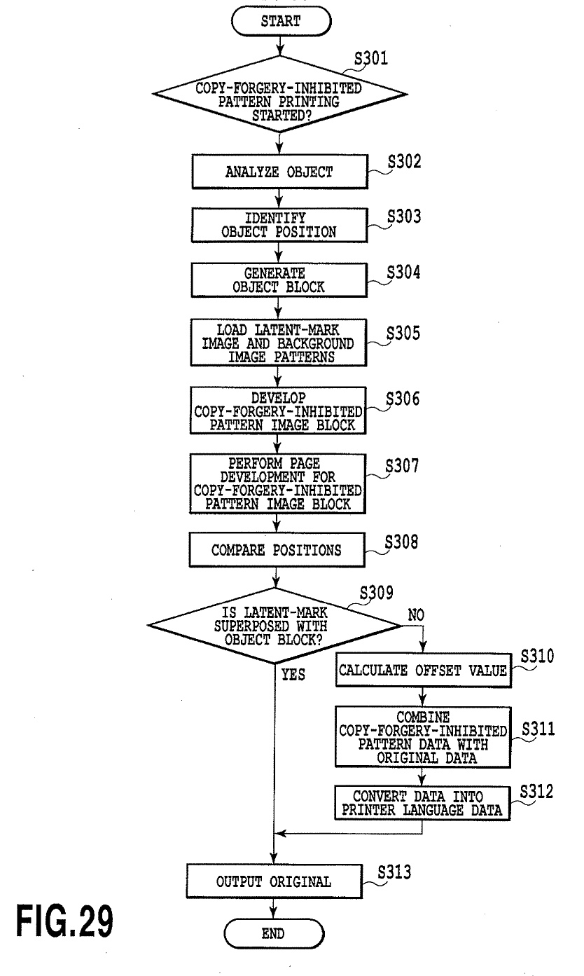

FIG. 29 is a flowchart showing the copy-forgery-inhibited pattern printing processing according to this embodiment.

When a user employs the host computer 2700, which serves as an image processing apparatus, and enters an instruction for the printing of a document that includes text, pictures and graphics, upon detection of this instruction, the processing in FIG. 29 is initiated (step S301). First, the CPU 2601 analyzes data for the document for which printing is requested, and determines whether the document includes significant information indicating a significant image for a document, e.g., information indicating text, a picture, graphics or a table (step S302).

Then, the CPU 2601 determines the location of or the range of the significant information relative to a data area to be printed (step S303). Generally, objects (individual components constituting a document) are present in a document generated by the application of the host computer 2700, and an image that consists of significant information is also managed as an object. That is, a table, graphics and text that constitute a document are managed as individual objects. Further, coordinate information indicating the location of an object arranged in a document and an attribute (e.g., a picture, graphics or a table) of the object are added to object information. The CPU 2601 determines the coordinate positions for the individual objects, and identifies the locations of all the objects in the document for which printing is requested.

When the CPU 2601 has identified the object locations, the CPU 2601 forms an object block for each object (step S304).

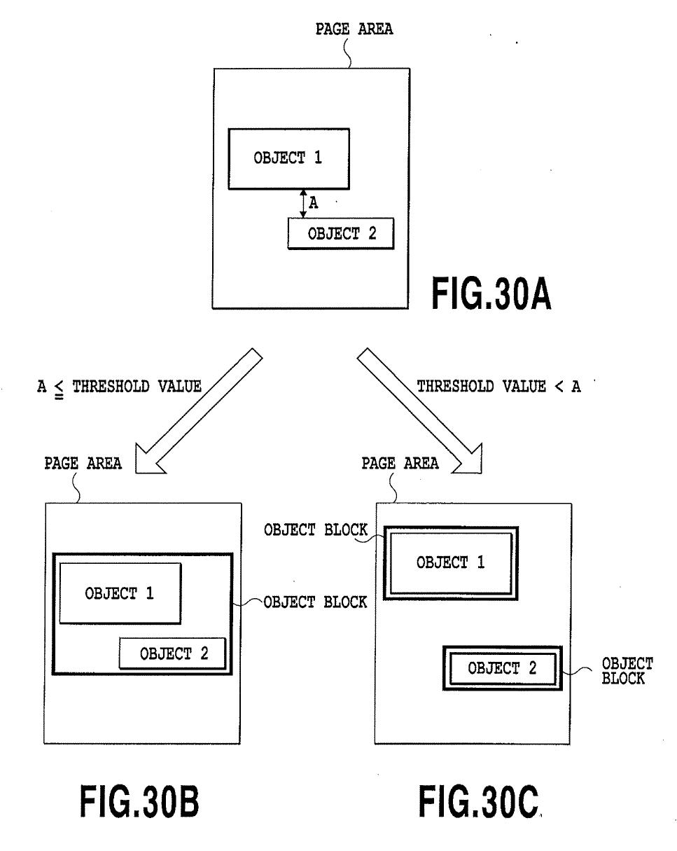

FIGS. 30A to 30C are diagrams for explaining the concept of forming object blocks. In the examples shown in FIGS. 30A to 30C, there are two objects (object 1 and object 2) identified by the CPU 2601. In the object block formation process, basically, a rectangular area enclosing an object is defined, and when a plurality of objects are present, one rectangular area that encloses these objects is defined when the distances between the objects are shorter than a predetermined distance. In the example in FIG. 30B, one rectangular area for enclosing a plurality of objects is defined, and in the example in FIG. 30C, rectangular areas are defined to enclose the individual objects.

In FIG. 30A, A denotes the vertical (sub-scanning direction) distance between objects. These objects are not limited to a rectangular shape as shown in FIG. 30. A rectangle is employed in FIGS. 30A to 30C only to simplify the explanation, and when the range wherein the object of a picture is present is, for example, an elliptic area, this shape is regarded as a range. In this case, according to this embodiment, a rectangle in which this ellipse is inscribed is calculated, and the distance A between the objects is obtained as the distance between the rectangle and the other rectangle, as shown in FIG. 30A.

When the distance A between the object 1 and the object 2 is equal to or smaller than a threshold value predesignated for the image processing apparatus of this embodiment, the CPU 2601 forms these two objects into a single block (FIG. 30B). On the other hand, when the distance A between the two objects is greater than the threshold value, the CPU 2601 forms the two objects into separate blocks (FIG. 30C). It should be noted that the threshold value can be determined based on the actual results obtained by printing a document that includes an object for which a copy-forgery-inhibited pattern image is applied, or based on how the latent-mark appeared when this document was copied. When, for example, a great threshold value is set so that, even when the distance between objects is comparatively long, multiple blocks are to be formed into one block, the following problem would occur. The number of areas for which a copy-forgery-inhibited pattern image is combined is increased, and a large amount of recording agent, such as toner, is consumed. Thus, the quality of all the resulting printing may be reduced. To avoid this problem, a user may set the threshold value.

In the examples in FIGS. 30B and 30C, object block formation is performed, so that one object or multiple objects are completely enclosed in an object block or object blocks. Specifically, a margin is provided for all sides of an object and a rectangular shape is maintained.

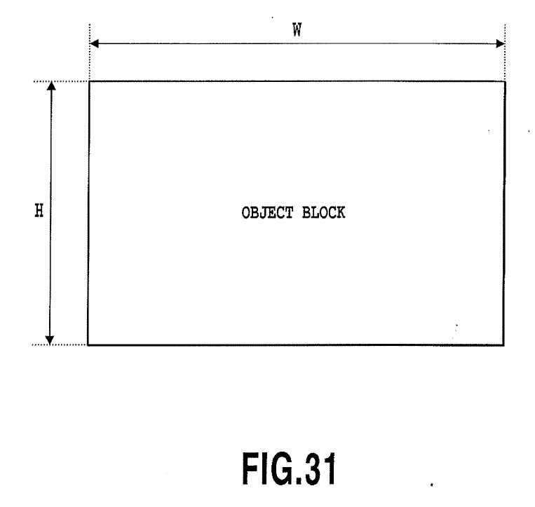

FIG. 31 is a diagram for explaining the structure of an object block. In FIG. 31, W denotes the number of pixels for an object block in the main scanning direction, and H denotes the number of pixels for the object block in the sub-scanning direction. As well as for the calculation of the distance between objects, basically the values H and W are the number of pixels respectively arranged in the directions of a rectangle that is obtained by providing a margin for a rectangle in which the object is inscribed. However, the values H and W can also be defined while taking into account the boundary of a storage medium that serves as the RAM 2602 or the main memory of the image processing apparatus of this embodiment, the number of bits for each pixel that constitutes copy-forgery-inhibited pattern image data that will be described later, and the bus width and the access to the RAM 2602 or the apparatus storage medium. For example, when the data bus width of the RAM 2602 is 64 bits and the number of bits for one pixel of a copy-forgery-inhibited pattern image is one bit, a multiple of 64 need only be designated for the values of W and H, so that the operation, such as bit shift calculation, is not required. Further, an overhead (load) for access control of the RAM 2602 can be reduced. Additionally, when the pixel start position of the object block in the main scanning direction is also limited to a multiple of 64, the processing is even more easily performed.

According to the above example of object block formation, only the vertical (sub-scanning direction) distance has been employed to determine whether an object should be formed into a block. The present invention is not limited to this example. For example, in accordance with a document type, only the transverse (main scanning direction) distance may be employed to determine block formation. Or, both the vertical distance and the transverse distance may be employed to determine block formation. In this case, when the vertical distance and the transverse distance are equal to or smaller than corresponding threshold values, it may be determined that objects are to be formed into a single block, or when at least either the vertical distance or the transverse distance is equal to or smaller than a corresponding threshold value, it may be determined that objects are to be formed into a single block. As well as the threshold value, this rule can be determined in accordance with a copy-forgery-inhibited pattern printing structure.

Further, in the above explanation, the threshold value is previously set. However, this value may be set via the user interface of the image processing apparatus, or by the application of the host computer 2700.

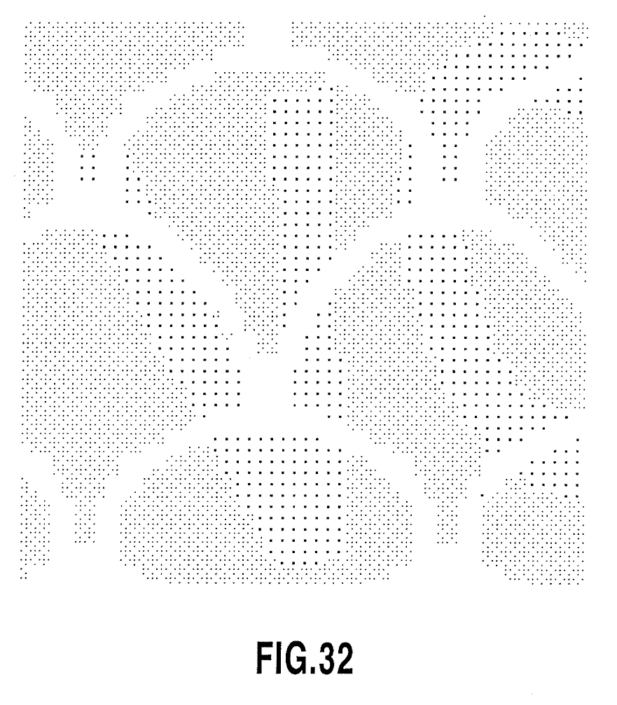

When the object block formation process is completed, a copy-forgery-inhibited pattern image preparation process is performed. The CPU 2601 fetches pattern data for a background image and pattern data for a latent-mark image, for which the user has adjusted the densities (step S305). As shown in FIG. 32, generally, a copy-forgery-inhibited pattern image is formed of a latent-mark constituted by large groups of dots and a background image where dots are dispersed. In FIG. 32, latent-mark “VOID” is set, and part of the “V” and the “O” are enlarged. It should be noted that a camouflage pattern, used by a copy-forgery-inhibited pattern image technique, is added to the copy-forgery-inhibited pattern image in FIG. 32.

Sequentially, the CPU 2601 generates a copy-forgery-inhibited pattern image using the pattern for the latent-mark image and the pattern for the background image. That is, for the pattern data of a latent-mark image and the pattern data of a background image, the CPU 2601 employs a dither pattern having a different number of output lines to generate copy-forgery-inhibited pattern image data (step S306). In this case, as previously described, this copy-forgery-inhibited pattern image is generated as image data of a pattern block having a rectangular shape, which is a unit for which the copy-forgery-inhibited pattern image is add combined.

The present invention is not limited to the bit accuracy for each pixel of image data that are generated using a dither pattern and through a dithering process. That is, the bit accuracy is not specifically designated so long as the condition of a printer that prints generated image data is maintained, and image data generated through the dithering process may be either one bit or four bits for one pixel. Furthermore, when dot data for a copy-forgery-inhibited pattern image are to be prepared based on pattern data of a latent-mark image and a background image, the quantization method is not limited to the dither method described above, and another quantization method, such as an error diffusion method, can be employed.

When copy-forgery-inhibited pattern image data are generated, and the size of the object block generated at step S304 is obviously smaller than the size of a copy-forgery-inhibited pattern block to be generated, the size of the copy-forgery-inhibited pattern block is reduced.

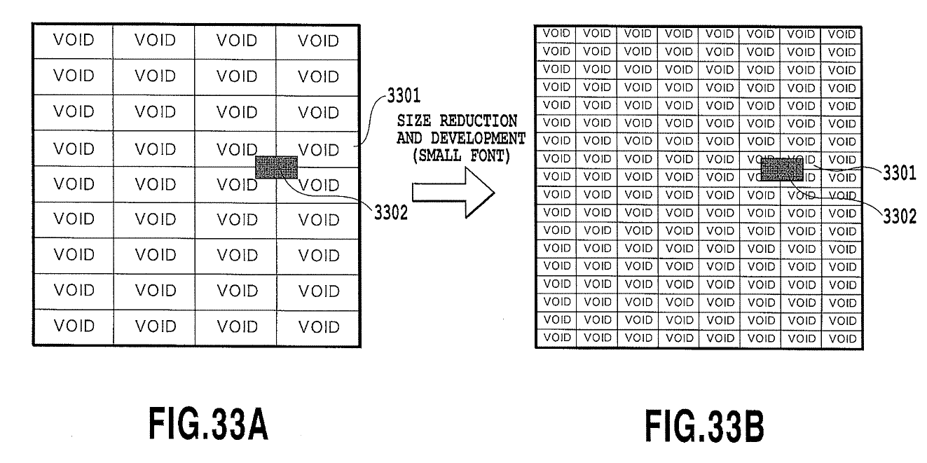

FIGS. 33A and 33B are diagrams for explaining this size reduction. As shown in FIG. 33A, a minimum object block 3302 in an image to be printed is selected and its size is compared with that of a copy-forgery-inhibited pattern block 3301. Then, it may occur that the object block 3302 is smaller than a “VOID” area that is the latent-mark of the copy-forgery-inhibited pattern block 3301, so that even by superimposing the object block 3302 with latent-mark “VOID”, the entire latent-mark does not fit in the object block. In this case, a copy-forgery-inhibited pattern block size reduction process is performed. According to this embodiment, when at least either the vertical or transverse ratio of the copy-forgery-inhibited pattern block to the object block is equal to or greater than a predetermined value, the size reduction process is performed in accordance with the ratio. FIG. 33B is a diagram showing the relationship between a copy-forgery-inhibited pattern block and an object block after size reduction process has been performed. As shown in FIG. 33B, as a result of the size reduction, the entire latent-mark of the copy-forgery-inhibited pattern block 3301 is fitted into the object block 3302 by superimposition. In FIGS. 33A and 33B, only the latent-mark “VOID” is clearly shown in the pattern blocks 3301, and a background image combined with the latent-mark is shown as a blank. However, this is done merely to simplify the drawings, and as described above, the background image is present in the blank portion.

In this embodiment, when it is determined that, because of the size reduction of the copy-forgery-inhibited pattern image (a copy-forgery-inhibited pattern block), the copy-forgery-inhibited pattern image will no longer be effective when it is printed, a user is notified via an interface by the use of a message indicating that effect. That is, when the size of a copy-forgery-inhibited pattern image is reduced, on printed matter to which this copy-forgery-inhibited pattern is add combined, a latent-mark may appear because a density difference between the background and the latent-mark is increased, or on the duplication of the printed matter, the latent-mark may not appear clearly. In order to avoid a size reduction that is the cause of such a phenomenon, a notification is transmitted to the user. For example, the above described reduction ratio is employed as a reference for transmitting this notification, and when a ratio is equal to or smaller than this value, a notification is transmitted to the user. For the transmission of the notification, a message may be displayed on the display medium of the operating portion of the apparatus, an LED maybe turned on or may blink, or a message may be displayed on the CRT 2710 via the application provided for the host computer 2700.

The CPU 2601 performs page development, in the RAM 2602, for the thus generated copy-forgery-inhibited pattern block data (S307). For this development, the copy-forgery-inhibited pattern blocks may be simply repetitively developed, or the blocks may be developed by shifting the phases of the copy-forgery-inhibited pattern blocks.

When page development of copy-forgery-inhibited pattern image data in the RAM 2602 is completed, the CPU 2601 compares the position of the generated copy-forgery-inhibited pattern block with the position of the object block (S308).

When the entire latent-mark of the copy-forgery-inhibited pattern block is superposed with the object block while the copy-forgery-inhibited pattern blocks obtained by page development maintain the positional relationship, a synthesis process is performed for data for the copy-forgery-inhibited pattern block and data for a document for which printing is requested. That is, combination is performed only for the object block portion. Then, the resultant data are changed to data in a description language that the printer 2500 can translate, and the data are output to the printer via the PRTC 2608 and the bidirectional interface 2610 (S309 and S313).

When it is determined at step S309 that, at the current position, the copy-forgery-inhibited pattern block developed in the RAM 2602 is not superposed with the object block, an offset position is calculated (S310).

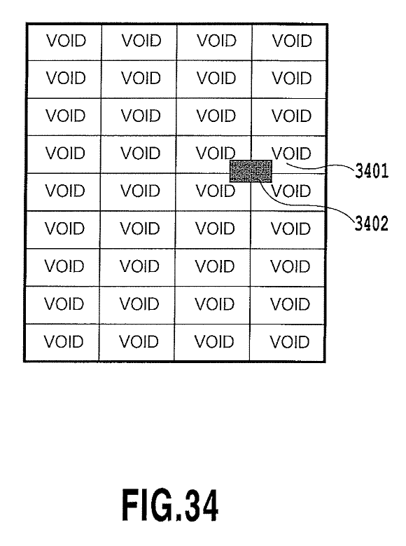

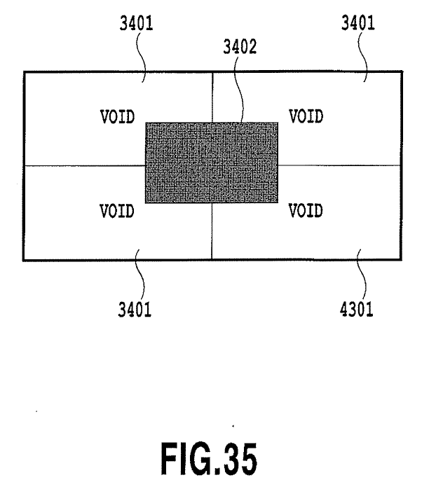

FIG. 34 is a diagram for explaining adjustment of an offset position, and showing the positional relationship between multiple copy-forgery-inhibited pattern blocks 3401, developed in the RAM 2602, and an object block 3402. FIG. 35 is an enlarged diagram showing the positional relationship between the object block 3402 and the surrounding copy-forgery-inhibited pattern blocks 3401. As shown in FIG. 35, when the pattern blocks 3401 are added to the object block 3402 with maintaining this positional relationship, the latent-mark in the copy-forgery-inhibited pattern block 3401 is not superposed with the object block 3401. Therefore, a latent-mark is not present in an object that is printed, and only a background is present. As a result, a copy-forgery-inhibited pattern printing function is not demonstrated in the printed matter.

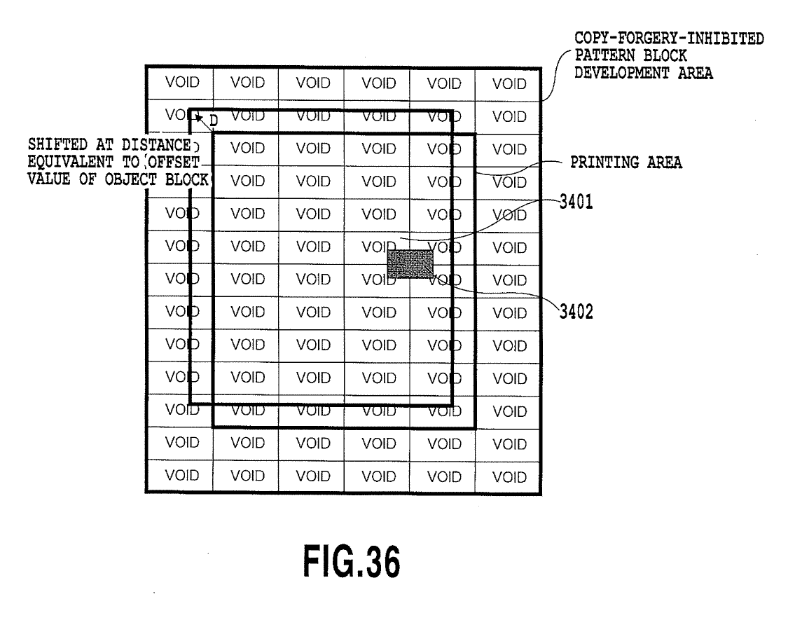

To resolve this problem, the CPU 2601 compares the position of the object block and the position of the copy-forgery-inhibited pattern block after the page development has been performed, and adjusts the position of the copy-forgery-inhibited pattern block. Specifically, as shown in FIG. 36, the read start addresses of copy-forgery-inhibited pattern blocks that are page developed in the RAM 2602 are shifted a distance equivalent to an offset value D, so that the object block 3402 is superposed with the copy-forgery-inhibited pattern block 3401. Then, only a copy-forgery-inhibited pattern block superposed with the object block 3402 is combined with this object block (step S311). When the positions of blocks are not superposed in a document for one page and there are a plurality of objects having different shift values, the above shifting process and combination process are repeated.

Furthermore, when the capacity of the RAM 2602 for the performance of page development for the copy-forgery-inhibited pattern image data is sufficiently large, during the page development process for the copy-forgery-inhibited pattern image data the printing size is extended by adding the offset value to all the sides. Through this process, the address for fetching copy-forgery-inhibited pattern image data need only be shifted, so that a pattern block can be added to an object block.

The CPU 2601 applies, only for the object block obtained at step S304, the process for combining copy-forgery-inhibited pattern image data with the document for which printing is requested is performed. The combined data are changed to description language data that the printer 2500 can translate, and the obtained data are output via the PRTC 2608 and the bidirectional interface 2610 (steps S312 and S313).

It should be noted that, at step S309, when the entire latent-mark of the copy-forgery-inhibited pattern block fits in the object block, this state is regarded as a superposed state. However, in this invention, the superposed state is not limited to this. For example, so long as one part of a latent-mark is included in an object block, it maybe determined, depending on the contents or the type of the latent-mark, that the pattern block is superposed with the object block. That is, any state wherein a combined image can provide the function of a copy-forgery-inhibited pattern is available.

As described above, according to the third embodiment, based on image data to be printed, an object that is an image to which a copy-forgery-inhibited pattern image should be add combined is detected, and an object block is defined as an area so that a copy-forgery-inhibited pattern image can be add combined to this object. And a copy-forgery-inhibited pattern image is add combined only within the range defined by the object block. Therefore, a copy-forgery-inhibited pattern image can be automatically add combined at an appropriate position, and the operation by which a user sets an area for the addition of a copy-forgery-inhibited pattern image is not required.

Further, when a copy-forgery-inhibited pattern image to be add combined is larger than an object block, so that the function of a copy-forgery-inhibited pattern add combined may not be fulfilled, the size of a copy-forgery-inhibited pattern image is reduced so that it may be added to an object block. Therefore, when there is a large difference in size between a set copy-forgery-inhibited pattern image and an object to which a pattern is to be added, this difference can be appropriately resolved, and the pattern can be add combined.

### FOURTH EMBODIMENT

A fourth embodiment of the present invention relates to a method by which in the case that a copy-forgery-inhibited pattern image is inclined and arranged, a copy-forgery-inhibited pattern image appropriately is add combined to an individual object block. According to this embodiment, when a copy-forgery-inhibited pattern image is inclined and added, the function of a copy-forgery-inhibited pattern can be appropriately provided in accordance with this inclination.

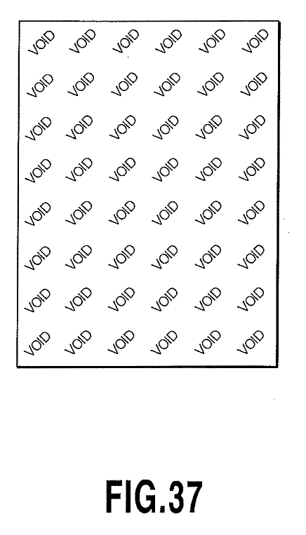

As shown in FIG. 37, there is a case where a copy-forgery-inhibited pattern image is add combined in an inclined manner. After an object block has been generated (step S304 in FIG. 29), a process according to this inclination is performed. More specifically, when a copy-forgery-inhibited pattern image designated by a user is to be arranged as inclined arrangement (upper right or lower right), the copy-forgery-inhibited pattern image may not be satisfactorily added to an object block, depending on the size (e.g., the font size of a character pattern) and the inclination of the copy-forgery-inhibited pattern image. As explained in the third embodiment, for example, a phenomenon may occur where the entire latent-mark is not present in the object block.

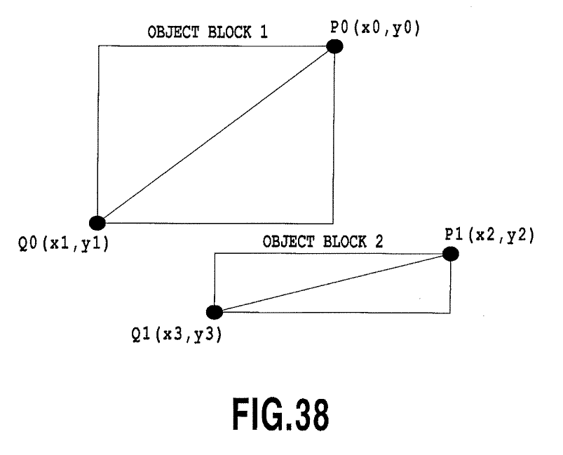

Thus, in this embodiment, first, as shown in FIG. 38, the inclination of a diagonal is calculated for each object block on a page. FIG. 38 is a diagram showing an example for calculating the inclinations of two object blocks when an inclined copy-forgery-inhibited pattern block in diagonally right up is designated. Assume that, as shown in FIG. 38, the upper right coordinate position P0 of object block 1 is (x0, y0) and the lower left coordinate position Q0 is (x1, y1). Further, assume that the upper right coordinate position P1 of object block 2 is (x2, y2) and the lower left coordinate position Q1 is (x3, y3). At this time, parameters indicating the individual inclinations are (y0−y1)/(x0−x1) for the object block 1 and (y2−y3)/(x2−x3) for the object block 2. The CPU 2601 employs these parameters to determine the inclinations of copy-forgery-inhibited pattern images, and generates copy-forgery-inhibited pattern image data for the individual objects.

Specifically, the inclination of a copy-forgery-inhibited pattern block to be add combined to a document that is to be printed is determined based on the size of the designated latent-mark block and the inclination parameter for each object. Then, a plurality of the determined copy-forgery-inhibited pattern blocks are arranged and developed as copy-forgery-inhibited pattern image data in the RAM 2602, as shown in FIG. 37. This developed data are generated for each object. As well as in the third embodiment, the process of S308 and following steps in FIG. 29 is performed for each object, and as a result, an image to be printed (a document image) wherein a copy-forgery-inhibited pattern image is add combined only to an object is completed.

In the explanation for this embodiment, an example wherein the number of object blocks is two has been employed. Similarly, when more than two object blocks are present, the same process is performed for each of them, and the inclination of a copy-forgery-inhibited pattern image is designated. As well as in the third embodiment, when the minimum object block is much smaller than the copy-forgery-inhibited pattern block, first, the size of the pattern block is reduced, and then a copy-forgery-inhibited pattern image is generated. Furthermore, as well as in the third embodiment, when the forgery prevention effect, which is a copy-forgery-inhibited pattern image function, is not satisfactorily demonstrated as the result of size reduction, a notification to that effect is transmitted to a user.

### FIFTH EMBODIMENT

In the third and the fourth embodiments, copy-forgery-inhibited pattern image data, which are generated using a copy-forgery-inhibited pattern image designated by a user, are developed in the RAM 2602 in consonance with a page to be printed, and are combined with a document to be printed. However, instead of being developed for the entire page, the copy-forgery-inhibited pattern image maybe developed only within a range wherein an object block is present. In this case, a copy-forgery-inhibited pattern image need not be a formed of a block.

According to this embodiment, since copy-forgery-inhibited pattern image data need be developed only within a range wherein an object block is located, the processing speed can be increased. Specifically, an area equivalent to the image (page) size wherein a copy-forgery-inhibited pattern image is to be developed is initialized using a fixed value. That is, this area is set as an area wherein no copy-forgery-inhibited pattern image is present. Thereafter, in the initialized area of the image size, a copy-forgery-inhibited pattern image is developed only within the range wherein an object block is present. As another method, an area in which to develop copy-forgery-inhibited pattern image data is formed as an area for one set of copy-forgery-inhibited pattern image data. Then, when this area is to be combined with a document to be printed, the document is scanned, and each time the location of an object block is reached, copy-forgery-inhibited pattern image data are add combined by repetitively referring to areas wherein the latent-mark data are developed. In either case, so long as the boundary of the RAM 2602 and the data bit width are taken into account for determining the size of a latent-mark, the processing speed can be increased.

The above described third to the fifth embodiments have the following features.

(1) An image processing apparatus performing a process for adding a copy-forgery-inhibited pattern image including a latent mark image and a background image to an image to be printed, the apparatus comprising:

object detecting means for detecting an object as an element constituting the image to be printed in the image;

block generating means for generating an object block as an area to which the copy-forgery-inhibited pattern image is add combined for the detected object; and

combining means for add combining the copy-forgery-inhibited pattern image to the object block.

(2) An image processing apparatus according to the above section (1), wherein when the object detecting means detects a plurality of objects, the block generating means generates the object block as the area containing some of the plurality of objects.

(3) An image processing apparatus according to the above section (1) or (2), wherein the copy-forgery-inhibited pattern image is generated as a copy-forgery-inhibited pattern block having a give shape, and the combining means superposes the object block and the copy-forgery-inhibited pattern block on each other so as to add combine the copy-forgery-inhibited pattern image to the object block.

(4) An image processing apparatus according to the above sections (3), wherein when the object block and the copy-forgery-inhibited pattern block have a predetermined size relation therebetween in which the object block is smaller than the copy-forgery-inhibited pattern block and then a function of a copy-forgery-inhibited pattern in superposing of the object block and the copy-forgery-inhibited pattern block is not fulfilled, the combining means reduces a size of the copy-forgery-inhibited pattern block according to a difference in sizes and adds the copy-forgery-inhibited pattern image to the object block.

(5) An image processing apparatus according to the above sections (4), further comprising means for, when a reduction ratio of the copy-forgery-inhibited pattern block size reduction by the combining means is a predetermined ratio at which the function of the copy-forgery-inhibited pattern is not fulfilled, notifying a user of that effect.

(6) An image processing apparatus according to any one of the above sections from (3) to (5), wherein the combining means arranges a plurality of copy-forgery-inhibited pattern blocks on an area having a same size as an area of whole of the image to be printed for superposing the area on which the plurality of copy-forgery-inhibited pattern blocks are arranged and the area of the whole image on each other, to add combine the copy-forgery-inhibited pattern image to the object block.

(7) An image processing apparatus according to any one of the above sections from (3) to (5), wherein the combining means compares a position of the object block and a position of the copy-forgery-inhibited pattern block, and, when a distance between the object block and the copy-forgery-inhibited pattern block is greater than a predetermined distance, shift whole data of the area on which the plurality of copy-forgery-inhibited pattern blocks are arranged so that the distance between the blocks becomes smaller than the predetermined distance.

(8) An image processing apparatus according to the above section (6) or (7), wherein a position of the object block in the area of whole of the image to be printed is defined in data bit width basis of a memory for storing data of that area.

(9) An image processing apparatus according to any one of the above sections from (6) to (8), wherein respective numbers of pixels constituting the object block in the image to be printed, in a main scanning direction and a sub-scanning direction, correspond to a data bit width of a memory for storing data of the area of the image to be printed.

(10) An image processing apparatus according to any one of the above sections from (3) to (9), wherein when the copy-forgery-inhibited pattern block is arranged at angle other than 0 degree relative to a main scanning direction, the combining means calculates an angle parameter of the object block, and determines an angle of the copy-forgery-inhibited pattern block arranged in the memory storing the data of the area of the image to be printed.

(11) A copy-forgery-inhibited pattern add combined image generating method for add combining a copy-forgery-inhibited pattern image including a latent mark image and a background image to an image to be printed, the method comprising:

an object detecting step for detecting an object as an element constituting the image to be printed in the image;

a block generating step for generating an object block as an area to which the copy-forgery-inhibited pattern image is add combined for the detected object; and

a combining step for add combining the copy-forgery-inhibited pattern image to the object block.

(12) A method according to the above section (11), wherein when the object detecting step detects a plurality of objects, the block generating step generates the object block as the area containing some of the plurality of objects.

(13) A method according to the above section (11) or (12), wherein the copy-forgery-inhibited pattern image is generated as a copy-forgery-inhibited pattern block having a give shape, and the combining step superposes the object block and the copy-forgery-inhibited pattern block on each other so as to add combine the copy-forgery-inhibited pattern image to the object block.

(14) A method according to the above sections (13), wherein when the object block and the copy-forgery-inhibited pattern block have a predetermined size relation therebetween in which the object block is smaller than the copy-forgery-inhibited pattern block and then a function of a copy-forgery-inhibited pattern in superposing of the object block and the copy-forgery-inhibited pattern block is not fulfilled, the combining step reduces a size of the copy-forgery-inhibited pattern block according to a difference in sizes and adds the copy-forgery-inhibited pattern image to the object block.

(15) A method according to the above sections (14), further comprising step for, when a reduction ratio of the copy-forgery-inhibited pattern block size reduction by the combining step is a predetermined ratio at which the function of the copy-forgery-inhibited pattern is not fulfilled, notifying a user of that effect.

(16) A method according to any one of the above sections from (13) to (15), wherein the combining step arranges a plurality of copy-forgery-inhibited pattern blocks on an area having a same size as an area of whole of the image to be printed for superposing the area on which the plurality of copy-forgery-inhibited pattern blocks are arranged and the area of the whole image on each other, to add combine the copy-forgery-inhibited pattern image to the object block.

(17) A method according to any one of the above sections from (13) to (15), wherein the combining step compares a position of the object block and a position of the copy-forgery-inhibited pattern block, and, when a distance between the object block and the copy-forgery-inhibited pattern block is greater than a predetermined distance, shift whole data of the area on which the plurality of copy-forgery-inhibited pattern blocks are arranged so that the distance between the blocks becomes smaller than the predetermined distance.

(18) A method according to the above section (16) or (17), wherein a position of the object block in the area of whole of the image to be printed is defined in data bit width basis of a memory for storing data of that area.

(19) A method according to any one of the above sections from (16) to (18), wherein respective numbers of pixels constituting the object block in the image to be printed, in a main scanning direction and a sub-scanning direction, correspond to a data bit width of a memory for storing data of the area of the image to be printed.

(20) A method according to any one of the above sections from (13) to (19), wherein when the copy-forgery-inhibited pattern block is arranged at angle other than 0 degree relative to a main scanning direction, the combining step calculates an angle parameter of the object block, and determines an angle of the copy-forgery-inhibited pattern block arranged in the memory storing the data of the area of the image to be printed.

(21) A program causing a computer to function as an image processing apparatus performing a process for add combining a copy-forgery-inhibited pattern image including a latent mark image and a background image to an image to be printed, the apparatus comprising:

object detecting means for detecting an object as an element constituting the image to be printed in the image;

block generating means for generating an object block as an area to which the copy-forgery-inhibited pattern image is add combined for the detected object; and

combining means for add combining the copy-forgery-inhibited pattern image to the object block.

### OTHER EMBODIMENT

The embodiments described above have been explained on the assumption that the processing for add combining a copy-forgery-inhibited pattern image is performed by a host computer. However, the present invention is not limited to this configuration. The same processing may be performed by, for example, a printer, or a so-called multifunctional apparatus that includes a printing mechanism, a scanner and a transmission function.

Further, the present invention can be applied for a system constituted by a plurality of apparatuses, such as a computer, an interface apparatus, a reader and a printer, or an apparatus, such as a multifunctional apparatus, a printer or a facsimile machine, that is constituted as a single unit.

The object of the present invention is also achieved by permitting the computer (or a CPU or an MPU) of a system or an apparatus to read and execute program code on a storage medium on which the program code that performs the processing in the flowcharts for the above embodiments. In this case, the program code read from the storage medium provides the functions of the embodiments, and the program code and the storage medium on which the program code is recorded constitutes the present invention.

The storage medium for supplying the program code can, for example, be a floppy (trademark) disk, a hard disk, an optical disk, a magneto-optical disk, a CD-ROM, a CD-R, a magnetic tape, a non-volatile memory card or a ROM.

Further, the present invention not only includes a case wherein the functions of the above embodiments are provided by executing program code read by a computer, but also a case wherein, based on the instructions provided by the program code, the OS (Operating System) operated by the computer actually performs part or all of the processes and functions provided by the above embodiments.

Furthermore, the present invention also includes a case wherein the program code read from the storage medium is written to a memory prepared on a function extension board inserted into the computer or in a function extension unit connected to the computer, and based on the instructions contained in the program code, a CPU included on the function extension board or in the function extension unit can actually perform part or all of the processes and functions provided by the above embodiments.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-352207, filed Dec. 6, 2005, Japanese Application No. 2006-043157, filed Feb. 20, 2006, which are hereby incorporated by reference herein in their entirety.

What is claimed is:

1. An image processing apparatus generating a combined image by combining a copy-forgery-inhibited pattern image and an original image, said apparatus comprising:
an attribute determining unit which determines a type of attribute information of each of pixels in the original image based on a pixel value of the pixel in the original image; and
a generating unit which generates the combined image by determining a pixel value of the pixel in the combined image, based on the type of the determined attribute information of a pixel in the original image which is corresponding to the pixel in the combined image.

2. An image processing apparatus generating a combined image by combining a copy-forgery-inhibited pattern image and an original image, said apparatus comprising:
an attribute determining unit which determines a type of attribute information of each of pixels in the original image based on a type of an object including the pixels; and
a generating unit which generates the combined image by determining a pixel value of the pixel in the combined image, said pixel corresponding to the pixel in the original image, based on the type of the attribute information determined by said attribute determining unit.

3. An image processing apparatus as claimed in claim 1, wherein said generating unit generates the combined image by,
in a first case that an object pixel, for which an image processing is performed, is s pixel having a first type of attribute information that is determined by said attribute determining unit,
determining the pixel value of the pixel in the combined image, said pixel corresponding to the object pixel, based on the pixel value of the object pixel, and
in a second case that the object pixel is s pixel having a second type of attribute information, which is determined by said attribute determining unit, and is other than the first type of attribute information,
determining the pixel value of the pixel in the combined image, said pixel corresponding to the object pixel, based on the pixel value of the pixel in the copy-forgery-inhibited pattern image, said pixel corresponding to the object pixel.

4. An image processing apparatus as claimed in claim 3, wherein said generating unit generates the combined image by,
in the first case,
determining the pixel value of the pixel in the combined image, said pixel corresponding to the object pixel, so that said pixel value is equal to the pixel value of the object pixel, and
in the second case,
determining the pixel value of the pixel in the combined image, said pixel corresponding to the object pixel, so that said pixel value is equal to the pixel value of the pixel in the copy-forgery-inhibited pattern image, said pixel corresponding to the object pixel.

5. An image processing apparatus as claimed in claim 3, wherein said generating unit generates the combined image by,
in the second case,
determining the pixel value of the pixel in the combined image, said pixel corresponding to the object pixel, based on the pixel value of the pixel in the copy-forgery-inhibited pattern image, said pixel corresponding to the object pixel, and the pixel value of the object pixel.

6. An image processing apparatus as claimed in claim 5, wherein said generating unit generates the combined image by,
in the first case,
determining the pixel value of the pixel in the combined image, said pixel corresponding to the object pixel, so that said pixel value is equal to the pixel value of the object pixel, and
in the second case,
determining the pixel value of the pixel in the combined image, said pixel corresponding to the object pixel, so that said pixel value is equal to the pixel value of not smaller one between the pixel value of the pixel in the copy-forgery-inhibited pattern image and the pixel value of the object pixel.

7. An image processing apparatus as claimed in claim 5, wherein the first type of the attribute information includes picture attribute information and graphic attribute information,
the second type of the attribute information includes character attribute information and line attribute information.

8. An image processing apparatus generating a combined image by combining an original image and a first image, said apparatus comprising:
an attribute determining unit which determines which type of attribute information does the type of the attribute information of each of pixels in the original image correspond to, among predetermined plurality of types of attribute information;
a selecting unit which selects at least one type of attribute information from the predetermined plurality of types of attribute information, on the basis of an instruction by a user; and
a generating unit which generates the combined image by determining a pixel value of the pixel in the combined image, said pixel corresponding to the pixel in the original image, based on the type of the attribute information determined by said attribute determining unit and the type of the attribute information selected by said selecting unit.

9. An image processing apparatus as claimed in claim 8, further comprising area a selecting unit which selects an area in the original image on the basis of an instruction by a user, and
herein said generating unit determines the pixel value of the pixel in the combined image, based on the area selected by said area selecting unit in addition to the type of the attribute information determined by said attribute determining unit and the type of the attribute information selected by said selecting unit.

10. An image processing apparatus as claimed in claim 8, wherein said selecting unit includes
a position designation unit which designates a position in the original image on the basis of an instruction by a user; and
an attribute information type selecting unit which selects a type of attribute information of the pixel which corresponds to the position designated by said position designation unit.

11. An image processing apparatus as claimed in claim 8, wherein said position designation unit includes
a control unit which controls a display on a display screen to display the original image in a condition of capable of distinguishing the pixel of a first type of attribute information which is determined by said attribute determining unit from the pixel of a second type of attribute information which is determined by said attribute determining unit, the second type of attribute information being different from the first type of attribute information; and
a second position designation unit which designates a position in the original image displayed on the display screen by said control unit, on the basis of an instruction by a user.

12. An image processing apparatus as claimed in claim 8, wherein said selecting unit includes
a second generating unit which generates a second combined image;
a control unit which controls a display on a display screen to display the second combined image generated by said second generating unit;
a position designation unit which designates a position in the second combined image displayed on the display by said control unit, on the basis of an instruction by a user; and
an attribute information type selecting unit which selects a type of attribute information of the pixel which corresponds to the position designated by said position designation unit, and
wherein the second combined image is generated by
performing a process for combining the pixel of a first type of attribute information, which is determined by said attribute determining unit, and the pixel in the first image, said pixel corresponding to the pixel of the first type of attribute information; and
non-performing a process for combining the pixel of a second type of attribute information that differs from the first type of attribute information, which is determined by said attribute determining unit, and the pixel in the first image, said pixel corresponding to the pixel of the second type of attribute information.

13. A control method of an image processing apparatus generating a combined image by combining a copy-forgery-inhibited pattern image and an original image, said method comprising:
an attribute determining step for determining a type of attribute information of each of pixels in the original image based on a pixel value of the pixel in the original image; and
a generating step for generating the combined image by determining a pixel value of the pixel in the combined image, based on the type of the determined attribute information of a pixel in the original image which is corresponding to the combined image.

14. A control method of an image processing apparatus generating a combined image by combining a copy-forgery-inhibited pattern image and an original image, said method comprising:
an attribute determining step for determining a type of attribute information of each of pixels in the original image based on a type of an object including the pixels; and
a generating step for generating the combined image by determining a pixel value of the pixel in the combined image, said pixel corresponding to the pixel in the original image, based on the type of the attribute information determined by said attribute determining step.

15. A control method as claimed in claim 13, wherein said generating step generates the combined image by,
in a first case that an object pixel, for which an image processing is performed, is s pixel having a first type of attribute information that is determined by said attribute determining step,
determining the pixel value of the pixel in the combined image, said pixel corresponding to the object pixel, based on the pixel value of the object pixel, and
in a second case that the object pixel is s pixel having a second type of attribute information, which is determined by said attribute determining step, and is other than the first type of attribute information,
determining the pixel value of the pixel in the combined image, said pixel corresponding to the object pixel, based on the pixel value of the pixel in the copy-forgery-inhibited pattern image, said pixel corresponding to the object pixel.

16. A control method as claimed in claim 15, wherein said generating step generates the combined image by,
in the first case,
determining the pixel value of the pixel in the combined image, said pixel corresponding to the object pixel, so that said pixel value is equal to the pixel value of the object pixel, and
in the second case,
determining the pixel value of the pixel in the combined image, said pixel corresponding to the object pixel, so that said pixel value is equal to the pixel value of the pixel in the copy-forgery-inhibited pattern image, said pixel corresponding to the object pixel.

17. A control method as claimed in claim 15, wherein said generating step generates the combined image by,
in the second case,
determining the pixel value of the pixel in the combined image, said pixel corresponding to the object pixel, based on the pixel value of the pixel in the copy-forgery-inhibited pattern image, said pixel corresponding to the object pixel, and the pixel value of the object pixel.

18. A control method as claimed in claim 17, wherein said generating step generates the combined image by,
in the first case,
determining the pixel value of the pixel in the combined image, said pixel corresponding to the object pixel, so that said pixel value is equal to the pixel value of the object pixel, and
in the second case,
determining the pixel value of the pixel in the combined image, said pixel corresponding to the object pixel, so that said pixel value is equal to the pixel value of not smaller one between the pixel value of the pixel in the copy-forgery-inhibited pattern image and the pixel value of the object pixel.

19. A control method as claimed in claim 17, wherein the first type of the attribute information includes picture attribute information and graphic attribute information,
the second type of the attribute information includes character attribute information and line attribute information.

20. A control method of an image processing apparatus generating a combined image by combining an original image and a first image, said method comprising:
attribute determining step for determining which type of attribute information does the type of the attribute information of each of pixels in the original image correspond to, among predetermined plurality of types of attribute information;
selecting step for selecting at least one type of attribute information from the predetermined plurality of types of attribute information, on the basis of an instruction by a user; and
generating step for generating the combined image by determining a pixel value of the pixel in the combined image, said pixel corresponding to the pixel in the original image, based on the type of the attribute information determined by said attribute determining step and the type of the attribute information selected by said selecting step.

21. A control method as claimed in claim 20, further comprising area selecting step for selecting an area in the original image on the basis of an instruction by a user, and
herein said generating step determines the pixel value of the pixel in the combined image, based on the area selected by said area selecting step in addition to the type of the attribute information determined by said attribute determining step and the type of the attribute information selected by said selecting step.

22. A control method as claimed in claim 20, wherein said selecting step includes
position designation step for designating a position in the original image on the basis of an instruction by a user; and
attribute information type selecting step for selecting a type of attribute information of the pixel which corresponds to the position designated by said position designation step.

23. A control method as claimed in claim 20, wherein said position designation step includes
control step for controlling a display on a display screen to display the original image in a condition of capable of distinguishing the pixel of a first type of attribute information which is determined by said attribute determining step from the pixel of a second type of attribute information which is determined by said attribute determining step, the second type of attribute information being different from the first type of attribute information; and
second position designation step for designating a position in the original image displayed on the display screen by said control step, on the basis of an instruction by a user.

24. A control method as claimed in claim 20, wherein said selecting step includes
second generating step for generating a second combined image;
control step for controlling a display on a display screen to display the second combined image generated by said second generating step;
position designation step for designating a position in the second combined image displayed on the display by said control step, on the basis of an instruction by a user; and
attribute information type selecting step for selecting a type of attribute information of the pixel which corresponds to the position designated by said position designation step, and
wherein the second combined image is generated by
performing a process for combining the pixel of a first type of attribute information, which is determined by said attribute determining step, and the pixel in the first image, said pixel corresponding to the pixel of the first type of attribute information; and
non-performing a process for combining the pixel of a second type of attribute information that differs from the first type of attribute information, which is determined by said attribute determining step, and the pixel in the first image, said pixel corresponding to the pixel of the second type of attribute information.

25. A program for causing a computer to execute steps of the method claimed in any one of claims 13 to 24.

26. A storage medium which stores a program claimed in claim 25 and is computer readable.
